(19) United States
(12) Patent Application Publication
(10) Pub. No.: US 2020/0024556 A1
(43) Pub. Date: Jan. 23, 2020

(54) NONWOVEN MATERIAL FOR CLEANING AND SANITIZING SURFACES

(71) Applicant: Georgia-Pacific Nonwovens LLC, Atlanta, GA (US)

(72) Inventors: Steven Lester Cavadeas, Franklin, WI (US); Jacek K Dutkiewicz, Cordova, TN (US)

(73) Assignee: Georgia-Pacific Nonwovens LLC, Atlanta, GA (US)

(21) Appl. No.: 16/477,407

(22) PCT Filed: Jan. 12, 2018
(86) PCT No.: PCT/US18/13536

§ 371 Date: Jul. 11, 2019

Related U.S. Application Data
(60) Provisional application No. 62/445,682, filed on Jan. 12, 2017.

(51) Int. Cl. C11D 17/04; C11D 3/22; C11D 3/37; C11D 3/20; C11D 3/48; C11D 3/30; C11D 1/74; B32B 5/26; B32B 5/02; D04H 1/425; D04H 1/4374; D04H 1/541; D04H 1/593; B08B 1/00

(52) U.S. Cl. CPC C11D 17/049; B32B 2432/00; C11D 3/3749; C11D 3/3715; C11D 3/2086; C11D 3/48; C11D 3/30; C11D 1/74; B32B 5/26; B32B 5/022; D04H 1/425; D04H 1/4374; D04H 1/541; D04H 1/593; B08B 1/006; B32B 2262/062; C11D 3/222

(57) ABSTRACT

Nonwoven materials having at least one layer are provided, as well as their use in cleaning articles. More particularly, the nonwoven materials can include a rough outer surface useful for scrubbing purposes. Alternatively or additionally, the nonwoven materials can include a carrier composition including a binder and a blocking agent. The carrier composition can repel a sanitizing agent, such as a quaternary ammonium compound, from the surface of the nonwoven material.

### 1. FIELD OF THE INVENTION

The presently disclosed subject matter relates to new nonwoven materials and their use in cleaning articles. In certain aspects, the presently disclosed subject matter relates to nonwoven materials including a rough outer surface useful for scrubbing and cleaning purposes. The presently disclosed subject matter also provides nonwoven materials that can be used in combination with a sanitizing agent.

### 2. BACKGROUND OF THE INVENTION

Nonwoven materials are important in a wide range of cleaning articles, including cleaning wipes, cloths, and sheets. Nonwoven materials made from synthetic and cellulose fibers are suitable for cleaning applications because they can be a disposable and cost-effective single-use alternative to existing fabric cloths and sponges. In some applications, the nonwoven materials are treated with a cleaning solution to create a nonwoven material infused with a cleaning agent to aid in dirt, stain, or odor removal. The cleaning agent may also have biocidal properties to sanitize or disinfect surfaces. Wet wipes often attract and collect particles better than dry alternatives, although dry wipes may have electrostatic properties to assist in attracting and collecting such particles.

Cleaning wipes are used in a broad range of applications, including household, personal care, and industrial applications. It is desirable to have a durable wipe that does not disintegrate upon use. For cleaning purposes, ideal materials are flexible in order to conform to the surface being cleaned. It is also beneficial to create thinner wipes that require less material and which are simple to manufacture. Additionally, for purposes of dirt and stain removal, it is advantageous to create a wipe with a rough outer surface that can be used to scrub and loosen particles on tacky or stained surfaces.

As mentioned above, nonwoven materials can be treated with a cleaning solution to form a wet wipe. For example, it can be desirable to treat a nonwoven material with a liquid including a sanitizing agent. Cationic compounds, such as quaternary ammonium compounds, are commonly used as a sanitizing agent. However, such cationic compounds can be attracted to and absorbed into nonwoven materials. As the liquid is released from the nonwoven material, for example, during cleaning, a portion of the cationic compound can remain in the nonwoven material, thus reducing the sanitizing capacity of a cleaning wipe.

Thus, there remains a need for a durable nonwoven material that can be used in cleaning applications and that can effectively sanitize and scrub surfaces. The disclosed subject matter addresses these needs.

### 3. SUMMARY

The presently disclosed subject matter provides for a nonwoven material comprising at least one layer, at least two layers, at least three layers, at least four layers, or at least five layers, where each of the layers has a specific layered construction. In certain embodiments, the nonwoven material includes a layer with at least one rough outer surface. The rigidity of the rough outer surface is controlled by the temperature at which the nonwoven material is stabilized or by otherwise heating the outer layer of the nonwoven material. The rough outer surface of the nonwoven material is suitable for cleaning applications. Additionally or alternatively, the nonwoven material can include a carrier composition comprising a binder and a blocking agent. The carrier composition can repel a sanitizing agent from the surface of the nonwoven material.

In certain aspects, the disclosed subject matter provides for a multi-layer nonwoven material having a first outer layer containing synthetic fibers, a second outer layer containing cellulose fibers and/or synthetic fibers, and a carrier composition comprising a binder and a blocking agent, wherein the binder is present in the nonwoven material in an amount of from about 2 wt-% to about 30 wt-% and the blocking agent is present in the nonwoven material in an amount of from about 0.1 wt-% to about 10 wt-%. The first outer layer can have a static coefficient of friction ranging from about 0.01 to about 3.0 and a kinetic coefficient of friction ranging from about 0.0001 to about 2.0.

In certain embodiments, the multi-layer nonwoven material can comprise from about 10 wt-% to about 90 wt-% of cellulose fibers and from about 10 wt-% to about 90 wt-% of synthetic fibers. The synthetic fibers can be bicomponent fibers. In certain embodiments, the first layer further comprises cellulose fibers and the second layer comprises both cellulose fibers and synthetic fibers.

In certain embodiments, the blocking agent is an alkali metal salt. For example, the alkali metal salt can be a potassium metal salt such as potassium citrate monohydrate. In certain embodiments, the blocking agent is a non-ionic surfactant. For example, the blocking agent can be an alcohol ethoxylate compound, such as Tergitol 15-S-12, or a polysorbate compound, such as Polysorbate 20. In certain embodiments, the binder can be a cationic binder.

In certain embodiments, the multi-layer nonwoven material has a basis weight of from about 30 gsm to about 200 gsm. In certain embodiments, the multi-layer nonwoven material has a caliper of from about 0.3 mm to about 2.0 mm.

In certain embodiments, the nonwoven material has a CDW tensile strength of greater than about 200 g/inch, or greater than about 400 g/inch. The nonwoven material can have a MDD tensile strength of greater than about 300 g/inch, or greater than about 800 g/inch. The nonwoven material can further include a solution comprising a sanitizing agent. In certain embodiments, the solution can comprise from about 0.05 wt-% to about 5 wt-% of the sanitizing agent. The sanitizing agent can be a quaternary ammonium compound, such as dioctyldecyl dimethyl ammonium chloride, octyl decyl dimethyl ammonium chloride, alkyl dimethyl benzyl ammonium chloride, or a combination thereof. In certain embodiments, the nonwoven material has a quat depletion of at least about 40% as compared to an initial amount of the quaternary ammonium compound in the solution before the solution is applied to the nonwoven material. In certain embodiments, the nonwoven material further includes an anti-microbial agent.

In certain embodiments, the multi-layer nonwoven material can further have an intermediate layer. The intermediate layer can contain cellulose fibers and/or bicomponent fibers. In particular embodiments, the first outer layer contains bicomponent fibers having a dtex value that is greater than the dtex value of bicomponent fibers in the second outer layer. The multi-layer nonwoven material can further have a first intermediate layer between the first outer layer and the second outer layer. The first intermediate layer can contain cellulose fibers. The multi-layer nonwoven material can further have a second intermediate layer that is adjacent to the first outer layer. The second intermediate layer can contain bicomponent fibers. The multi-layer nonwoven material can further have a third intermediate layer that is adjacent to the second outer layer. The third intermediate layer can contain bicomponent fibers.

The foregoing has outlined broadly the features and technical advantages of the present application in order that the detailed description that follows may be better understood. Additional features and advantages of the application will be described hereinafter which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### 4. BRIEF DESCRIPTION OF THE DRAWINGS

FIG. 1 depicts the two-layer nonwoven material of Example 1. Note that in FIG. 1 and subsequent Figures, rows correspond to layers of the material and provide the composition of each layer.

FIG. 2 depicts the two-layer nonwoven material of Example 2.

FIG. 3 provides photographs of the rough outer surfaces of three samples of the two-layer nonwoven material of Example 2. Each sample was stabilized at a different temperature.

FIG. 4 provides photographs of the rough outer surfaces of three samples of the two-layer nonwoven material of Example 2. The outer surface is dyed to provide contrast. Each sample was stabilized at a different temperature.

FIG. 5 provides microphotographs of the rough outer surfaces of three samples of the two-layer nonwoven material of Example 2. Each sample was stabilized at a different temperature.

FIG. 6 provides microphotographs of the cross-sections of three samples of the two-layer nonwoven material of Example 2. Each sample was stabilized at a different temperature.

FIGS. 7A-7D provide illustrations of the friction profiles of the nonwoven materials of Example 3. The friction profiles correspond to the force necessary to move the material across a surface for a certain distance at a constant speed. Each of the Figures provides friction profiles for nonwoven materials which were stabilized at three different temperatures. FIG. 7A provides the friction profiles of 50 gsm nonwoven materials. FIG. 7B provides the friction profiles of 60 gsm nonwoven materials. FIG. 7C provides the friction profiles of 70 gsm nonwoven materials. FIG. 7D provides the friction profiles of 80 gsm nonwoven materials.

FIGS. 8A-8B provide illustrations of the coefficients of friction of the nonwoven materials of Example 3 when rubbed on a black glass surface. The nonwoven materials were stabilized at temperatures from 138° C. to 148° C. and had basis weights of 50 gsm, 60 gsm, 70 gsm, and 80 gsm. FIG. 8A provides the static coefficients of friction and FIG. 8B provides the kinetic coefficients of friction.

FIGS. 9A-9B provide illustrations of the coefficients of friction of the nonwoven materials of Example 3 when rubbed on a ceramic surface. The nonwoven materials were stabilized at temperatures from 138° C. to 148° C. and had basis weights of 50 gsm, 60 gsm, 70 gsm, and 80 gsm. FIG. 9A provides the static coefficients of friction and FIG. 9B provides the kinetic coefficients of friction.

FIGS. 10A-10B provide illustrations of the coefficients of friction of the nonwoven materials of Example 3 when rubbed on a vinyl surface. The nonwoven materials were stabilized at temperatures from 138° C. to 148° C. and had basis weights of 50 gsm, 60 gsm, 70 gsm, and 80 gsm. FIG. 10A provides the static coefficients of friction and FIG. 10B provides the kinetic coefficients of friction.

FIGS. 11A-11B provide illustrations of the coefficients of friction of the nonwoven materials of Example 3 when rubbed on their own surfaces. The nonwoven materials were stabilized at temperatures from 138° C. to 148° C. and had basis weights of 50 gsm, 60 gsm, 70 gsm, and 80 gsm. FIG. 11A provides the static coefficients of friction and FIG. 11B provides the kinetic coefficients of friction.

FIG. 12 provides an illustration of the static coefficients of friction of the nonwoven materials in Example 3 when rubbed on a ceramic surface compared to three commercially available materials. In FIG. 12, each bar corresponds to a material which was stabilized at a temperature of 138° C., 143° C., or 147° C. and which has a basis weight of 50 gsm, 60 gsm, 70 gsm, or 80 gsm. The static coefficients of friction of the commercially available materials (Clorox (“C”), Gojo (“G”), and Big Jobs (“B”)) are also provided as bars in FIG. 12.

FIG. 13 provides an illustration of the static coefficients of friction of the nonwoven materials in Example 3 when rubbed on a vinyl surface compared to three commercially available materials. In FIG. 13, each bar corresponds to a material which was stabilized at a temperature of 138° C., 143° C., or 147° C. and which has a basis weight of 50 gsm, 60 gsm, 70 gsm, or 80 gsm. The static coefficients of friction of the commercially available materials (Clorox (“C”), Gojo (“G”), and Big Jobs (“B”)) are also provided as bars in FIG. 13.

FIG. 14 provides an illustration of the static coefficients of friction of the nonwoven materials in Example 3 when rubbed on their own surfaces compared to three commercially available materials. In FIG. 14, each bar corresponds to a material which was stabilized at a temperature of 138° C., 143° C., or 147° C. and which has a basis weight of 50 gsm, 60 gsm, 70 gsm, or 80 gsm. The static coefficients of friction of the commercially available materials (Clorox (“C”), Gojo (“G”), and Big Jobs (“B”)) are also provided for comparison.

FIG. 15 provides an illustration of the cleaning efficiency of the nonwoven materials of Example 4, which were stabilized at various processing temperatures, as compared to two commercially available products. In FIG. 15, each bar corresponds to a material which was stabilized at a temperature of 138° C., 143° C., or 147° C. and which has a basis weight of 50 gsm, 60 gsm, 70 gsm, or 80 gsm. The cleaning efficiencies of the commercially available materials (Clorox and Gojo) are provided for comparison.

FIG. 16 provides a plot of peak static force versus cleaning efficiency for the nonwoven materials of Example 4. Each data point represents a different nonwoven material having a peak static force and a cleaning efficiency. FIG. 16 includes a trend line to show the relationship between peak static force and cleaning efficiency.

FIG. 17 provides a plot of kinetic force versus cleaning efficiency for the nonwoven materials of Example 4. Each data point represents a different nonwoven material having a kinetic force and a cleaning efficiency. FIG. 17 includes a trend line to show the relationship between kinetic force and cleaning efficiency.

FIG. 18 provides a graph of the quat depletion of certain samples from Examples 7 and 8. In FIG. 18, the dashed line indicates the preferred minimum quat depletion based on cleaning solution with 0.292 wt-% of a quaternary ammonium compound.

### 5. DETAILED DESCRIPTION

As noted above, to date, there remains a need in the art for improved nonwoven materials for sanitizing and scrubbing surfaces. The presently disclosed subject matter provides a nonwoven material having at least one layer, and including a rough outer surface and/or a surface comprising a carrier composition suitable for repelling a sanitizing agent from the surface of the nonwoven material. The presently disclosed subject matter also provides methods for making such materials. These and other aspects of the disclosed subject matter are discussed more in the detailed description and examples.

### Definitions

The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used herein, a “nonwoven” refers to a class of material, including but not limited to textiles or plastics. Nonwovens are sheet or web structures made of fiber, filaments, molten plastic, or plastic films bonded together mechanically, thermally, or chemically. A nonwoven is a fabric made directly from a web of fiber, without the yarn preparation necessary for weaving or knitting. In a nonwoven, the assembly of fibers is held together by one or more of the following: (1) by mechanical interlocking in a random web or mat; (2) by fusing of the fibers, as in the case of thermoplastic fibers; or (3) by bonding with a cementing medium such as a natural or synthetic resin.

As used herein, the term “weight percent” is meant to refer to either (i) the quantity by weight of a constituent/component in the material as a percentage of the total dry weight of a layer of the material; or (ii) to the quantity by weight of a constituent/component in the material as a percentage of the total dry weight of the final nonwoven material or product.

The term “basis weight” as used herein refers to the quantity by weight of a compound over a given area. Examples of the units of measure include grams per square meter as identified by the acronym “gsm”.

As used herein, the term “cleaning efficiency” refers to the percentage of a mess removed by a material, when compared to the original amount of mess present. For example, cleaning efficiency can be calculated by determining the percentage of a known amount of mess that is picked up by a material upon cleaning the mess using the material.

As used herein, the term “coefficient of friction” refers to the ratio of the force of friction between two bodies and the normal force between the bodies. For example, and not limitation, the two bodies can be a nonwoven material and a surface. The “static coefficient of friction” refers to the coefficient of friction between two bodies that are not moving relative to each other. The “kinetic coefficient of friction” refers to the coefficient of friction between two bodies that are moving relative to each other. The static coefficient of friction and the kinetic coefficient of friction are both dimensionless values. A person having ordinary skill in the art will appreciate that the static coefficient of friction and the kinetic coefficient of friction are empirical measurements, and can be calculated experimentally for two bodies.

As used herein, the term “rough” or “roughness” refers to a textural quality of a nonwoven material. Rough can refer to the hand feel of a nonwoven material. Roughness can correspond to the harshness, rigidity, and/or abrasiveness of a nonwoven material.

As used herein, the term “blocking agent” refers to a chemical compound that can prevent a cationic compound, such as a quaternary ammonium compound, from absorbing into the nonwoven materials. For example, and not by limitation, the blocking agent can be a low molecular weight component. The low molecular weight component can be used in a carrier composition with a polymeric binder and can have a molecular weight that is less than that of the binder after cross-linking. In certain embodiments, the low molecular weight component can have a molecular weight of less than about 1500 g/mol.

As used herein, the term “sanitizing agent” refers to a compound that has biocidal properties. For example, a sanitizing agent can have antimicrobial, antibacterial, antiviral, antifungal, antiprotozoal and/or antiparasitic properties. Sanitizing agents can be capable of reducing or eliminating the presence of microbes, including bacteria, viruses, and fungi.

As used herein, the term “quat depletion” refers to the amount (e.g., weight percent) of a quaternary ammonium compound in a solution that has been released from a nonwoven material. For example, the solution can be released wringing, squeezing, pressing, or otherwise applying pressure to the nonwoven material. Quat depletion can be measured by titration of the released solution. Quat depletion can be compared to the initial amount of the quaternary ammonium compound in the solution prior to the solution being applied to the nonwoven material, to determine the percentage of the quaternary ammonium compound that was released by the nonwoven material.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to systems or processes, the term can mean within an order of magnitude, preferably within 5-fold, and more preferably within 2-fold, of a value.

### Fibers

The nonwoven material of the presently disclosed subject matter comprises one or more types of fibers. For example, the fibers can be natural, synthetic, or a mixture thereof. In certain embodiments, the nonwoven material can contain two or more layers, where each layer contains a specific fibrous content, which can include one or more of synthetic fibers, cellulose fibers, or a mixture thereof.

### Synthetic Fibers

In certain embodiments, the nonwoven material can include one or more synthetic layers. Any synthetic fibers known in the art can be used in a synthetic layer. In one embodiment, the synthetic fibers comprise bicomponent and/or mono-component fibers. Bicomponent fibers having a core and sheath are known in the art. Many varieties are used in the manufacture of nonwoven materials, particularly those produced for use in airlaid techniques. Various bicomponent fibers suitable for use in the presently disclosed subject matter are disclosed in U.S. Pat. Nos. 5,372,885 and 5,456,982, both of which are hereby incorporated by reference in their entireties. Examples of bicomponent fiber manufacturers include, but are not limited to, Trevira (Bobingen, Germany), Fiber Innovation Technologies (Johnson City, Tenn.) and ES Fiber Visions (Athens, Ga.).

Bicomponent fibers can incorporate a variety of polymers as their core and sheath components. Bicomponent fibers that have a PE (polyethylene) or modified PE sheath typically have a PET (polyethylene terephthalate) or PP (polypropylene) core. In one embodiment, the bicomponent fiber has a core made of polyester and sheath made of polyethylene.

The denier of the bicomponent fiber preferably ranges from about 1.0 dpf to about 4.0 dpf, and more preferably from about 1.5 dpf to about 2.5 dpf. The length of the bicomponent fiber can be from about 3 mm to about 36 mm, preferably from about 3 mm to about 12 mm, more preferably from about 3 mm to about 10 mm. In particular embodiments, the length of the bicomponent fiber is from about 2 mm to about 8 mm, or about 4 mm, or about 6 mm.

Bicomponent fibers are typically fabricated commercially by melt spinning. In this procedure, each molten polymer is extruded through a die, for example, a spinneret, with subsequent pulling of the molten polymer to move it away from the face of the spinneret. This is followed by solidification of the polymer by heat transfer to a surrounding fluid medium, for example chilled air, and taking up of the now solid filament. Non-limiting examples of additional steps after melt spinning can also include hot or cold drawing, heat treating, crimping and cutting. This overall manufacturing process is generally carried out as a discontinuous two-step process that first involves spinning of the filaments and their collection into a tow that comprises numerous filaments. During the spinning step, when molten polymer is pulled away from the face of the spinneret, some drawing of the filament does occur which can also be called the draw-down. This is followed by a second step where the spun fibers are drawn or stretched to increase molecular alignment and crystallinity and to give enhanced strength and other physical properties to the individual filaments. Subsequent steps can include, but are not limited to, heat setting, crimping and cutting of the filament into fibers. The drawing or stretching step can involve drawing the core of the bicomponent fiber, the sheath of the bicomponent fiber or both the core and the sheath of the bicomponent fiber depending on the materials from which the core and sheath are comprised as well as the conditions employed during the drawing or stretching process.

Bicomponent fibers can also be formed in a continuous process where the spinning and drawing are done in a continuous process. During the fiber manufacturing process it is desirable to add various materials to the fiber after the melt spinning step at various subsequent steps in the process. These materials can be referred to as “finish” and be comprised of active agents such as, but not limited to, lubricants and anti-static agents. The finish is typically delivered via an aqueous based solution or emulsion. Finishes can provide desirable properties for both the manufacturing of the bicomponent fiber and for the user of the fiber, for example in an airlaid or wetlaid process.

Numerous other processes are involved before, during and after the spinning and drawing steps and are disclosed in U.S. Pat. Nos. 4,950,541, 5,082,899, 5,126,199, 5,372,885, 5,456,982, 5,705,565, 2,861,319, 2,931,091, 2,989,798, 3,038,235, 3,081,490, 3,117,362, 3,121,254, 3,188,689, 3,237,245, 3,249,669, 3,457,342, 3,466,703, 3,469,279, 3,500,498, 3,585,685, 3,163,170, 3,692,423, 3,716,317, 3,778,208, 3,787,162, 3,814,561, 3,963,406, 3,992,499, 4,052,146, 4,251,200, 4,350,006, 4,370,114, 4,406,850, 4,445,833, 4,717,325, 4,743,189, 5,162,074, 5,256,050, 5,505,889, 5,582,913, and 6,670,035, all of which are hereby incorporated by reference in their entireties.

The presently disclosed subject matter can also include, but are not limited to, articles that contain bicomponent fibers that are partially drawn with varying degrees of draw or stretch, highly drawn bicomponent fibers and mixtures thereof. These can include, but are not limited to, a highly drawn polyester core bicomponent fiber with a variety of sheath materials, specifically including a polyethylene sheath such as Trevira T255 (Bobingen, Germany) or a highly drawn polypropylene core bicomponent fiber with a variety of sheath materials, specifically including a polyethylene sheath such as ES FiberVisions AL-Adhesion-C (Varde, Denmark). Additionally, Trevira T265 bicomponent fiber (Bobingen, Germany), having a partially drawn core with a core made of polybutylene terephthalate (PBT) and a sheath made of polyethylene can be used. The use of both partially drawn and highly drawn bicomponent fibers in the same structure can be leveraged to meet specific physical and performance properties based on how they are incorporated into the structure.

The bicomponent fibers of the presently disclosed subject matter are not limited in scope to any specific polymers for either the core or the sheath as any partially drawn core bicomponent fiber can provide enhanced performance regarding elongation and strength. The degree to which the partially drawn bicomponent fibers are drawn is not limited in scope as different degrees of drawing will yield different enhancements in performance. The scope of the partially drawn bicomponent fibers encompasses fibers with various core sheath configurations including, but not limited to concentric, eccentric, side by side, islands in a sea, pie segments and other variations. The relative weight percentages of the core and sheath components of the total fiber can be varied. In addition, the scope of this subject matter covers the use of partially drawn homopolymers such as polyester, polypropylene, nylon, and other melt spinnable polymers. The scope of this subject matter also covers multicomponent fibers that can have more than two polymers as part of the fibers structure.

In particular embodiments, the bicomponent fibers in a particular layer comprise from about 10 to about 100 percent by weight of the layer. In alternative embodiments, the bicomponent layer contains from about 10 gsm to about 50 gsm bicomponent fibers, or from about 20 gsm to about 50 gsm bicomponent fibers, or from about 30 gsm to about 40 gsm bicomponent fibers.

In particular embodiments, the bicomponent fibers are low dtex staple bicomponent fibers in the range of about 0.5 dtex to about 20 dtex. In certain embodiments, the dtex value is 5.7 dtex. In other certain embodiments, the dtex value is 1.7 dtex.

Other synthetic fibers suitable for use in various embodiments as fibers or as bicomponent binder fibers include, but are not limited to, fibers made from various polymers including, by way of example and not by limitation, acrylic, polyamides (including, but not limited to, Nylon 6, Nylon 6/6, Nylon 12, polyaspartic acid, polyglutamic acid), polyamines, polyimides, polyacrylics (including, but not limited to, polyacrylamide, polyacrylonitrile, esters of methacrylic acid and acrylic acid), polycarbonates (including, but not limited to, polybisphenol A carbonate, polypropylene carbonate), polydienes (including, but not limited to, polybutadiene, polyisoprene, polynorbomene), polyepoxides, polyesters (including, but not limited to, polyethylene terephthalate, polybutylene terephthalate, polytrimethylene terephthalate, polycaprolactone, polyglycolide, polylactide, polyhydroxybutyrate, polyhydroxyvalerate, polyethylene adipate, polybutylene adipate, polypropylene succinate), polyethers (including, but not limited to, polyethylene glycol (polyethylene oxide), polybutylene glycol, polypropylene oxide, polyoxymethylene (paraformaldehyde), polytetramethylene ether (polytetrahydrofuran), polyepichlorohydrin), polyfluorocarbons, formaldehyde polymers (including, but not limited to, urea-formaldehyde, melamine-formaldehyde, phenol formaldehyde), natural polymers (including, but not limited to, cellulosics, chitosans, lignins, waxes), polyolefins (including, but not limited to, polyethylene, polypropylene, polybutylene, polybutene, polyoctene), polyphenylenes (including, but not limited to, polyphenylene oxide, polyphenylene sulfide, polyphenylene ether sulfone), silicon containing polymers (including, but not limited to, polydimethyl siloxane, polycarbomethyl silane), polyurethanes, polyvinyls (including, but not limited to, polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone), polyacetals, polyarylates, and copolymers (including, but not limited to, polyethylene-co-vinyl acetate, polyethylene-co-acrylic acid, polybutylene terephthalate-co-polyethylene terephthalate, polylauryllactam-block-polytetrahydrofuran), polybutylene succinate and polylactic acid based polymers.

In particular embodiments, spunbond polypropylene fibers are used in a synthetic fiber layer. In certain embodiments, the synthetic fiber layer contains from about 5 gsm to about 20 gsm synthetic fibers, or about 10 gsm to about 15 gsm synthetic fibers.

### Cellulose Fibers

In addition to the use of synthetic fibers, the presently disclosed subject matter also contemplates the use of cellulose-based fibers. In certain embodiments, the nonwoven material can include one or more cellulosic layers having only cellulose fibers. Any cellulose fibers known in the art, including cellulose fibers of any natural origin, such as those derived from wood pulp or regenerated cellulose, can be used in a cellulosic layer. In certain embodiment, cellulose fibers include, but are not limited to, digested fibers, such as kraft, prehydrolyzed kraft, soda, sulfite, chemi-thermal mechanical, and thermo-mechanical treated fibers, derived from softwood, hardwood or cotton linters. In other embodiments, cellulose fibers include, but are not limited to, kraft digested fibers, including prehydrolyzed kraft digested fibers. Non-limiting examples of cellulose fibers suitable for use in this subject matter are the cellulose fibers derived from softwoods, such as pines, firs, and spruces. Other suitable cellulose fibers include, but are not limited to, those derived from Esparto grass, bagasse, kemp, flax, hemp, kenaf, and other lignaceous and cellulosic fiber sources. Suitable cellulose fibers include, but are not limited to, bleached Kraft southern pine fibers sold under the trademark FOLEY FLUFFS® (Buckeye Technologies Inc., Memphis, Tenn.). Additionally, fibers sold under the trademark CELLU TISSUE® (e.g., Grade 3024) (Clearwater Paper Corporation, Spokane, Wash.) are utilized in certain aspects of the disclosed subject matter.

The nonwoven materials of the disclosed subject matter can also include, but are not limited to, a commercially available bright fluff pulp including, but not limited to, southern softwood fluff pulp (such as Treated FOLEY FLUFFS®) northern softwood sulfite pulp (such as T 730 from Weyerhaeuser), or hardwood pulp (such as eucalyptus). While certain pulps may be preferred based on a variety of factors, any absorbent fluff pulp or mixtures thereof can be used. In certain embodiments, wood cellulose, cotton linter pulp, chemically modified cellulose such as cross-linked cellulose fibers and highly purified cellulose fibers can be used. Non-limiting examples of additional pulps are FOLEY FLUFFS® FFTAS (also known as FFTAS or Buckeye Technologies FFT-AS pulp), and Weyco CF401.

Other suitable types of cellulose fiber include, but are not limited to, chemically modified cellulose fibers. In particular embodiments, the modified cellulose fibers are crosslinked cellulose fibers. U.S. Pat. Nos. 5,492,759; 5,601,921; 6,159,335, all of which are hereby incorporated by reference in their entireties, relate to chemically treated cellulose fibers useful in the practice of this disclosed subject matter. In certain embodiments, the modified cellulose fibers comprise a polyhydroxy compound. Non-limiting examples of polyhydroxy compounds include glycerol, trimethylolpropane, pentaerythritol, polyvinyl alcohol, partially hydrolyzed polyvinyl acetate, and fully hydrolyzed polyvinyl acetate. In certain embodiments, the fiber is treated with a polyvalent cation-containing compound. In one embodiment, the polyvalent cation-containing compound is present in an amount from about 0.1 weight percent to about 20 weight percent based on the dry weight of the untreated fiber. In particular embodiments, the polyvalent cation containing compound is a polyvalent metal ion salt. In certain embodiments, the polyvalent cation containing compound is selected from the group consisting of aluminum, iron, tin, salts thereof, and mixtures thereof Any polyvalent metal salt including transition metal salts may be used. Non-limiting examples of suitable polyvalent metals include beryllium, magnesium, calcium, strontium, barium, titanium, zirconium, vanadium, chromium, molybdenum, tungsten, manganese, iron, cobalt, nickel, copper, zinc, aluminum and tin. Preferred ions include aluminum, iron and tin. The preferred metal ions have oxidation states of +3 or +4. Any salt containing the polyvalent metal ion may be employed. Non-limiting examples of suitable inorganic salts of the above metals include chlorides, nitrates, sulfates, borates, bromides, iodides, fluorides, nitrides, perchlorates, phosphates, hydroxides, sulfides, carbonates, bicarbonates, oxides, alkoxides phenoxides, phosphites, and hypophosphites. Non-limiting examples of suitable organic salts of the above metals include formates, acetates, butyrates, hexanoates, adipates, citrates, lactates, oxalates, propionates, salicylates, glycinates, tartrates, glycolates, sulfonates, phosphonates, glutamates, octanoates, benzoates, gluconates, maleates, succinates, and 4,5-dihydroxy-benzene-1,3-disulfonates. In addition to the polyvalent metal salts, other compounds such as complexes of the above salts include, but are not limited to, amines, ethylenediaminetetra-acetic acid (EDTA), diethylenetriaminepenta-acetic acid (DIPA), nitrilotri-acetic acid (NTA), 2,4-pentanedione, and ammonia may be used.

In one embodiment, the cellulose pulp fibers are chemically modified cellulose pulp fibers that have been softened or plasticized to be inherently more compressible than unmodified pulp fibers. The same pressure applied to a plasticized pulp web will result in higher density than when applied to an unmodified pulp web. Additionally, the densified web of plasticized cellulose fibers is inherently softer than a similar density web of unmodified fiber of the same wood type. Softwood pulps may be made more compressible using cationic surfactants as debonders to disrupt interfiber associations. Use of one or more debonders facilitates the disintegration of the pulp sheet into fluff in the airlaid process. Examples of debonders include, but are not limited to, those disclosed in U.S. Pat. Nos. 4,432,833, 4,425,186 and 5,776,308, all of which are hereby incorporated by reference in their entireties. One example of a debonder-treated cellulose pulp is FFLE+. Plasticizers for cellulose, which can be added to a pulp slurry prior to forming wetlaid sheets, can also be used to soften pulp, although they act by a different mechanism than debonding agents. Plasticizing agents act within the fiber, at the cellulose molecule, to make flexible or soften amorphous regions. The resulting fibers are characterized as limp. Since the plasticized fibers lack stiffness, the comminuted pulp is easier to densify compared to fibers not treated with plasticizers. Plasticizers include, but are not limited to, polyhydric alcohols such as glycerol, low molecular weight polyglycol such as polyethylene glycols, and polyhydroxy compounds. These and other plasticizers are described and exemplified in U.S. Pat. Nos. 4,098,996, 5,547,541 and 4,731,269, all of which are hereby incorporated by reference in their entireties. Ammonia, urea, and alkylamines are also known to plasticize wood products, which mainly contain cellulose (A. J. Stamm, Forest Products Journal 5(6):413, 1955, hereby incorporated by reference in its entirety).

In particular embodiments of the disclosed subject matter, GP4723, a fully treated cellulose pulp (available from Georgia-Pacific) is used in a cellulose fiber layer. Alternatively or additionally, GI4725, a cellulose fluff pulp (also available from Georgia-Pacific) is used in a cellulose fiber layer. In particular embodiments, the cellulose fiber layer contains from about 5 gsm to about 100 gsm cellulose fibers, or from about 7 gsm to about 50 gsm, or about 9 gsm to about 30 gsm.

### Additives

In addition to one or more fibrous layers, the presently disclosed nonwoven materials can further include additives. In certain embodiments, an additive can be applied to at least a portion of at least one outer layer of the nonwoven material. In certain embodiments, the nonwoven material can include a binder. In particular embodiments, the binder is a thermoplastic binder. In certain embodiments, the binder can be combined with a blocking agent to form a carrier composition prior to being applied to the nonwoven material. The nonwoven materials can further be treated with a liquid, such as a cleaning composition comprising a sanitizing agent, such as a cationic compound.

In certain embodiments, the nonwoven material can further contain other additives. In certain embodiments, the nonwoven material can include a dye or pigment. For example, in particular embodiments, the nonwoven material can include an anionic pigment. Additionally or alternatively, in certain embodiments, the nonwoven material can contain a lotion.

In certain embodiments, the nonwoven material can include an anti-microbial agent as an additive. The anti-microbial agent can be added to the nonwoven material prior to the sanitizing agent, and can be present in the nonwoven material when the nonwoven material is in dry form. For the purpose of example, and not limitation, suitable anti-microbial agents include: poly-amine compounds, such as Chitosan; essential oils, such as cinnamon oil and thyme oil; organic acids, such as lactic acid and citric acid; and certain aluminum compounds, as known in the art.

### Binders

Suitable binders include, but are not limited to, liquid binders and powder binders. Non-limiting examples of liquid binders include emulsions, solutions, or suspensions of binders. Non-limiting examples of binders include polyethylene powders, copolymer binders, vinylacetate ethylene binders, styrene-butadiene binders, urethanes, urethane-based binders, acrylic binders, thermoplastic binders, natural polymer based binders, and mixtures thereof. In certain embodiments, the binder is a cationic binder. For example, and not limitation, in certain embodiments, the binder is Duroset Elite Plus 299A.

For example, suitable binders include, but are not limited to, copolymers, vinylacetate ethylene (“VAE”) copolymers which can have a stabilizer, such as Wacker Vinnapas 192, Wacker Vinnapas EF 539, Wacker Vinnapas EP907, Wacker Vinnapas EP129, Celanese Dur-O-Set E130, Celanese Dur-O-Set Elite 130 25-1813 and Celanese Dur-O-Set TX-849, Celanese Dur-O-Set 25-010A, Celanese 75-524A, polyvinyl alcohol-polyvinyl acetate blends such as Wacker Vinac 911, vinyl acetate homopolymers, polyvinyl amines such as BASF Luredur, acrylics, cationic acrylamides, polyacryliamides such as Bercon Berstrength 5040 and Bercon Berstrength 5150, hydroxyethyl cellulose, starch such as National Starch CATO RTM 232, National Starch CATO RTM 255, National Starch Optibond, National Starch Optipro, or National Starch OptiPLUS, guar gum, styrene-butadienes, urethanes, urethane-based binders, thermoplastic binders, acrylic binders, and carboxymethyl cellulose such as Hercules Aqualon CMC. In certain embodiments, the binder is a natural polymer based binder. Non-limiting examples of natural polymer based binders include polymers derived from starch, cellulose, chitin, and other polysaccharides.

In certain embodiments, the binder is water-soluble. In one embodiment, the binder is a vinylacetate ethylene copolymer. One non-limiting example of such copolymers is EP907 (Wacker Chemicals, Munich, Germany). Vinnapas EP907 can be applied at a level of about 10% solids incorporating about 0.75% by weight Aerosol OT (Cytec Industries, West Paterson, N.J.), which is an anionic surfactant. Other classes of liquid binders such as styrene-butadiene and acrylic binders can also be used.

In certain embodiments, the binder is not water-soluble. Examples of these binders include, but are not limited to, Vinnapas 124 and 192 (Wacker) which can have an opacifier and whitener, including, but not limited to, titanium dioxide, dispersed in the emulsion. Other binders include, but are not limited to, Celanese Emulsions (Bridgewater, N.J.) Elite 22 and Elite 33.

In certain embodiments, the binder is a thermoplastic binder. Such thermoplastic binders include, but are not limited to, any thermoplastic polymer which can be melted at temperatures which will not extensively damage the cellulose fibers. Preferably, the melting point of the thermoplastic binding material will be less than about 175° C. Examples of suitable thermoplastic materials include, but are not limited to, suspensions of thermoplastic binders and thermoplastic powders. In particular embodiments, the thermoplastic binding material can be, for example, polyethylene, polypropylene, polyvinylchloride, and/or polyvinylidene chloride.

In particular embodiments, the vinylacetate ethylene binder is non-crosslinkable. In one embodiment, the vinylacetate ethylene binder is crosslinkable. In certain embodiments, the binder is WD4047 urethane-based binder solution supplied by HB Fuller. In one embodiment, the binder is Michem Prime 4983-45N dispersion of ethylene acrylic acid (“EAA”) copolymer supplied by Michelman. In certain embodiments, the binder is Dur-O-Set Elite 22LV emulsion of VAE binder supplied by Celanese Emulsions (Bridgewater, N.J.). As noted above, in particular embodiments, the binder is crosslinkable. It is also understood that crosslinkable binders are also known as permanent wet strength binders. A permanent wet-strength binder includes, but is not limited to, Kymene® (Hercules Inc., Wilmington, Del.), Parez® (American Cyanamid Company, Wayne, N.J.), Wacker Vinnapas or AF192 (Wacker Chemie AG, Munich, Germany), or the like. Various permanent wet-strength agents are described in U.S. Pat. Nos. 2,345,543, 2,926,116, and 2,926,154, the disclosures of which are incorporated by reference in their entirety. Other permanent wet-strength binders include, but are not limited to, polyamine-epichlorohydrin, polyamide epichlorohydrin or polyamide-amine epichlorohydrin resins, which are collectively termed “PAE resins”. Non-limiting exemplary permanent wet-strength binders include Kymene 557H or Kymene 557LX (Hercules Inc., Wilmington, Del.) and have been described in U.S. Pat. Nos. 3,700,623 and 3,772,076, which are incorporated herein in their entirety by reference thereto.

Alternatively, in certain embodiments, the binder is a temporary wet-strength binder. The temporary wet-strength binders include, but are not limited to, Hercobond® (Hercules Inc., Wilmington, Del.), Parez® 750 (American Cyanamid Company, Wayne, N.J.), Parez® 745 (American Cyanamid Company, Wayne, N.J.), or the like. Other suitable temporary wet-strength binders include, but are not limited to, dialdehyde starch, polyethylene imine, mannogalactan gum, glyoxal, and dialdehyde mannogalactan. Other suitable temporary wet-strength agents are described in U.S. Pat. No. 3,556,932, 5,466,337, 3,556,933, 4,605,702, 4,603,176, 5,935,383, and 6,017,417, all of which are incorporated herein in their entirety by reference thereto.

In particular embodiments, the binder can be Dur-O-Set 25-010A, Dur-O-Set Elite Ultra 25-135A, Vinnapas 192, Vinnapas RB18, Vinnapas RBG1, or a combination thereof. In certain embodiments, binders are applied as emulsions in amounts ranging from about 1 gsm to about 4 gsm, or from about 1 gsm to about 2 gsm, or from about 2 gsm to about 3 gsm. The binder can be applied to one side of a fibrous layer, preferably an externally facing layer. Alternatively, binder can be applied to both sides of a layer, in equal or disproportionate amounts. In certain embodiments, the binder can be present in the nonwoven material in an amount of from about 1 wt-% to about 50 wt-%, or from about 2 wt-% to about 30 wt-%, or from about 3 wt-% to about 25 wt-%, or from about 5 wt-% to about 20 wt-%, or from about 6 wt-% to about 15 wt-%.

### Carrier Compositions

As embodied herein, a binder can be combined with a blocking agent to form a carrier composition. For example, and not limitation, the binder can be a polymeric material. The carrier composition can be non-fibrous, i.e., include no fibrous materials. The carrier composition can be capable of repelling a sanitizing agent, such as a cationic compound, from the surface of the nonwoven material and/or can be capable of preventing absorption of the cationic compound into the nonwoven material. As embodied herein, the presence of a blocking agent can improve the release of the sanitizing agent from the nonwoven material

For example, and not limitation, suitable blocking agents include any compound capable of prevent absorption of a cationic compound into the nonwoven material. In certain embodiments, the blocking agent can be a non-ionic surfactant. In certain embodiments, the blocking agent can be a low molecular weight component. For the purpose of example and not limitation, suitable blocking agents include alkali metal salts. For example, suitable alkali metal salts include potassium salts such as potassium citrate monohydrate. For further example, and not limitation, the blocking agent can be an alcohol ethoxylate compound, such as Tergitol 15-S-12 (The DOW Chemical Company). In certain embodiments, the blocking agent can be can be a polysorbate compound, such as Polysorbate 20 (e.g., T-Maz 20, BASF). In certain embodiments, the carrier composition can comprise two or more blocking agents.

In particular embodiments, the blocking agent is Polysorbate 20. In certain embodiments, Polysorbate 20 is used in combination with one or more of Tergitol 15-S-12 and potassium citrate monohydrate. In other embodiments, the blocking agent is Tergitol 15-S-12, potassium citrate monohydrate, or a combination thereof.

In certain embodiments, the blocking agent is capable of being heated to a certain temperature without degrading. Certain compounds can degrade and cause processing issues, for example, by “smoking” during the drying process. In certain embodiments, the blocking agent can have a degradation point (i.e., the temperature at which oxidative degradation occurs) of greater than 270° F., greater than 290° F., greater than 300° F., or greater than 310° F.

In certain embodiments, one or more blocking agents are present in the nonwoven material in a total amount of from about 0.1 wt-% to about 10 wt-%, or from about 0.2 wt-% to about 9 wt-%, or from about 0.3 wt-% to about 8 wt-%, or from about 0.5 wt-% to about 7 wt-%, or from about 1 wt-% to about 5 wt-%. In certain embodiments, a carrier composition comprising a binder and one or more blocking agents is present in the nonwoven material in an amount of from about 1 wt-% to about 60 wt-%, or from about 2 wt-% to about 40 wt-%, or from about 3 wt-% to about 30 wt-%, or from about 5 wt-% to about 25 wt-%, or from about 6 wt-% to about 20 wt-%.

### Sanitizing Agents

As embodied herein, the nonwoven material can further include a sanitizing agent. In certain embodiments, the sanitizing agent can be present in a liquid solvent, for example, a water or an alcohol. For example, the sanitizing agent can be present in a solution in an amount ranging from about 0.001 wt-% to about 20 wt-%, or from about 0.01 wt-% to about 10 wt-%, or from about 0.05 wt-% to about 5 wt-%, or from about 0.1 wt-% to about 5 wt-%, or from about 0.5 wt-% to about 3 wt-%, or from about 0.7 wt-% to about 2 wt-%, or from about 0.9 wt-% to about 1 wt-% of the solution. The nonwoven material can be treated with a solution comprising the sanitizing agent after a carrier composition is applied to the nonwoven material.

Suitable sanitizing agents include cationic compounds. For purpose of example and not limitation, the cationic compound can be a quaternary ammonium compound. In their cation form, quaternary ammonium compounds have the formula NR₄⁺. The R groups can be alkyl or aryl groups. The cation can form a salt (NR₄⁺X⁻), for example, with any counter-ion that forms a salt soluble in the desired solvent. In certain embodiments, the quaternary ammonium compound is a halide salt, such as a chloride. Suitable quaternary ammonium compounds include alkyl ammonium halides, alkyl aryl ammonium halides, n-alkyl pyridinium halides, and the like. In certain embodiments, suitable quaternary ammonium compounds can include amide, ether, or ester linkages. In particular embodiments, the sanitizing agent is dioctyldecyl dimethyl ammonium chloride, octyl decyl dimethyl ammonium chloride, alkyl dimethyl benzyl ammonium chloride, or a combination thereof.

In certain embodiments, a liquid solvent containing the sanitizing agent is added to the nonwoven material in an amount corresponding to the dry weight of the nonwoven material. For example, and not limitation, the weight of liquid solvent applied to the nonwoven material can range from about 2 times the dry weight of the nonwoven material to about 5 times the weight of the nonwoven material.

### Nonwoven Materials

The presently disclosed subject matter provides for nonwoven materials having at least one layer. In certain embodiments, a nonwoven material contains at least two layers, wherein each layer comprises a specific fibrous content. In specific embodiments, the nonwoven material contains at least one layer comprising synthetic fibers and a second layer comprising cellulose fibers. In other embodiments, the nonwoven material contains at least two layers, each comprising synthetic fibers. In particular embodiments, a synthetic fiber layer can include bicomponent fibers. In certain embodiments, the nonwoven material is a single layer, comprising both cellulose fibers and synthetic fibers. In particular embodiments, the synthetic fibers are bicomponent fibers. In certain embodiments, an outer layer of the nonwoven material includes a rough outer surface.

In certain embodiments, the nonwoven material has at least two layers, wherein each layer comprises a specific fibrous content. In specific embodiments, the nonwoven material contains a bicomponent fiber layer and a synthetic fiber layer. In certain embodiments, one or more layers are bonded on at least a portion of at least one of their outer surfaces with binder. The binder can be a part of the carrier composition. It is not necessary that the binder chemically bond with a portion of the layer, although it is preferred that the binder remain associated in close proximity with the layer, by coating, adhering, precipitation, or any other mechanism such that it is not dislodged from the layer during normal handling of the layer. For convenience, the association between the layer and the binder discussed above can be referred to as the bond, and the compound can be said to be bonded to the layer.

In a particular embodiment, the first layer is composed of bicomponent fibers. A second layer disposed adjacent to the first layer is composed of synthetic fibers. In an alternative embodiment, the second layer is composed of cellulose fibers. In certain embodiments, the second layer is composed of both cellulose and synthetic fibers. In certain embodiments, the second layer is coated with binder on its outer surface.

In certain embodiments, the first layer contains from about 10 gsm to about 50 gsm of bicomponent fibers. In certain embodiments, the second layer contains from about 5 gsm to about 15 gsm of synthetic fibers. In particular embodiments, the synthetic fibers can include polypropylene. Additionally or alternatively, the second layer can contain from about 10 gsm to about 100 gsm of cellulose fibers.

In another embodiment, the first layer is composed of both cellulose fibers and synthetic fibers. A second layer disposed adjacent to the first layer is also composed of cellulose fibers and synthetic fibers. Each layer can contain from about 10 gsm to about 90 gsm, or from about 10 gsm to about 50 gsm of cellulose fibers. Each layer can contain from about 1 gsm to about 50 gsm, or from about 5 gsm to about 15 gsm of synthetic fibers. The first and second layers can have the same composition, or different compositions. In certain embodiments, the synthetic fibers can be bicomponent fibers.

In another embodiment, the nonwoven material has at least three layers, wherein each layer has a specific fibrous content. In certain embodiments, the first layer contains synthetic fibers. In certain embodiments, the synthetic fibers can be bicomponent fibers. A second layer disposed adjacent to the first layer contains synthetic fibers. A third layer disposed adjacent to the second layer may contain cellulose fibers or synthetic fibers. Optionally, additional layers may contain cellulose fibers or synthetic fibers.

In an alternative embodiment, the first layer contains bicomponent fibers. A second layer disposed adjacent to the first layer contains cellulose fibers. A third layer disposed adjacent to the second layer contains bicomponent fibers. The bicomponent fibers of the first layer and/or third layer can have specific dtex values. In certain embodiments, the first layer can contain bicomponent fibers having a higher dtex value than the bicomponent fibers of the third layer.

In a specific embodiment, the first layer comprises from about 10 gsm to about 50 gsm, or from about 20 gsm to about 50 gsm, or from about 25 gsm to about 40 gsm of bicomponent fibers. In certain embodiments, the bicomponent fibers have an eccentric core sheath configuration. In a specific embodiment, the second layer comprises from about 5 gsm to about 10 gsm bicomponent fibers and/or from about 9 gsm to about 30 gsm, or from about 20 gsm to about 25 gsm cellulose fibers. In another specific embodiment, the second layer comprises from about 5 gsm to about 20 gsm, or from about 10 gsm to about 15 gsm synthetic fibers. In a particular embodiment, the synthetic fibers comprise polypropylene.

In certain embodiments, the nonwoven material has at least four layers, wherein each layer has a specific fibrous content. In certain embodiments, the first layer contains synthetic fibers. The synthetic fibers can be bicomponent fibers. A second layer disposed adjacent to the first layer contains bicomponent fibers. A third layer disposed adjacent to the second layer contains cellulose fibers. A fourth layer disposed adjacent to the third layer contains synthetic fibers. In certain embodiments, the synthetic fibers can be bicomponent fibers. In particular embodiments, the first layer can contain bicomponent fibers having a higher dtex value than the bicomponent fibers of the fourth layer. The first layer and/or fourth layer can be coated with binder. In certain embodiments, the nonwoven material can include an additional layer disposed between the third and fourth layer and containing bicomponent fibers.

In certain embodiments of the presently disclosed subject matter, at least a portion of at least one outer layer is coated with binder. In particular embodiments of the disclosed subject matter, at least a portion of an outer layer is coated with binder in an amount ranging from about 1 gsm to about 4 gsm, or from about 1 gsm to about 2 gsm, or from about 2 gsm to about 3 gsm. In certain embodiments, at least a portion of at least one outer layer is coated with carrier composition. In particular embodiments of the disclosed subject matter, at least a portion of an outer layer is coated with binder in an amount ranging from about 1 gsm to about 15 gsm, or from about 2 gsm to about 10 gsm, or from about 3 gsm to about 8 gsm. Where the outer layer is coated with a carrier composition, the binder can be present in an amount ranging from about 1 gsm to about 10 gsm, or from about 2 gsm to about 9 gsm, or from about 2.5 gsm to about 8 gsm.

In certain embodiments of the nonwoven material, the range of the basis weight in a first layer is from about 5 gsm to about 100 gsm, or from about 5 gsm to about 50 gsm, or from about 20 gsm to about 40 gsm. The range of the basis weight in a second layer is from about 5 gsm to about 100 gsm, or from about 5 gsm to about 50 gsm, or from about 10 gsm to about 40 gsm. The first layer and the second layer can have the same basis weight or different basis weights. If additional layers are present, the basis weight of each ranges from about 5 gsm to about 100 gsm, or from about 5 gsm to about 50 gsm, or from about 10 gsm to about 40 gsm.

### Features of Nonwoven Material

In certain embodiments of the nonwoven material, the range of basis weight of the overall structure is from about 5 gsm to about 300 gsm, or from about 5 gsm to about 250 gsm, or from about 10 gsm to about 250 gsm, or from about 20 gsm to about 200 gsm, or from about 30 gsm to about 200 gsm, or from about 40 gsm to about 200 gsm, or from about 40 gsm to about 150 gsm, or from about 40 gsm to about 100 gsm. In particular embodiments, the basis weight of the overall structure is about 30 gsm, about 40 gsm, about 50 gsm, about 60 gsm, about 70 gsm, about 80 gsm, about 100 gsm, about 200 gsm, or about 400 gsm.

The caliper of the nonwoven material refers to the caliper of the entire material. In certain embodiments, the caliper of the material ranges from about 0.3 to about 4.0 mm, or from about 0.3 to about 3.0 mm, or from about 0.3 to about 2.0 mm, or from about 0.5 mm to about 1.5 mm, or from about 0.7 mm to about 1.0 mm. In particular embodiments, the caliper of the material is about 0.95 mm.

In certain embodiments, the nonwoven material can include from about 0 wt-% to about 99 wt-%, or from about 5 wt-% to about 95 wt-%, or from about 10 wt-% to about 90 wt-%, or from about 30 wt-% to about 80 wt-% of cellulose fibers based on the total weight of the nonwoven material. In certain embodiments, the nonwoven material can include from about 0 wt-% to about 99 wt-%, or from about 5 wt-% to about 95 wt-%, or from about 10 wt-% to about 90 wt-%, or from about 20 wt-% to about 70 wt-% of synthetic fibers. All or a portion of the synthetic fibers can be bicomponent fibers. In certain embodiments, the nonwoven material can include from about 2 wt-% to about 30 wt-%, or from about 2 wt-% to about 20 wt-%, or from about 2 wt-% to about 10 wt-% of a binder. In certain embodiments, the nonwoven material can include from about 0.1 wt-% to about 10 wt-%, or from about 0.2 wt-% to about 9 wt-%, or from about 0.3 wt-% to about 8 wt-% of one or more blocking agents.

The absorbency of a nonwoven material refers to its ability to absorb moisture. The absorbency can be measured based on the mass of absorbed liquid as compared to the mass of the nonwoven material (g/g) over a particular time period. In certain embodiments, the nonwoven materials can have an absorbency of greater than about 5 g/g, greater than about 6 g/g, greater than about 7 g/g, or greater than about 7.5 g/g as measured according to WSP 10.010.1.R3.

In certain embodiments, the nonwoven material can have a cross-direction wet (CDW) tensile strength of greater about 200 g/inch, greater than about 400 g/inch, greater than about 600 g/inch, greater than about 800 g/inch, or greater than about 1000 g/inch. As embodied herein, CDW tensile strength can be measured using standard INDA methods, such as WSP 110.4.R0. In certain embodiments, the CDW tensile strength can be tested immediately after soaking the nonwoven material for a period of time in a liquid, e.g., a solution including a sanitizing agent. Alternatively, the CDW tensile strength can be testing after aging the nonwoven material in a liquid.

In certain embodiments, the nonwoven material can have a machine-direction dry (MDD) tensile strength of greater than about 300 g/inch, greater than about 500 g/inch, greater than about 800 g/inch, greater than about 1000 g/inch, greater than about 1200 g/inch, or greater than about 1500 g/inch. As embodied herein, MDD tensile strength can be measured using standard INDA methods, for example WSP 110.4.R0.

In embodiments where the nonwoven material comprises a carrier composition and is treated with a solution comprising the sanitizing agent, the material can have improved release of the sanitizing agent as it releases the solution. For example, in certain embodiments the materials can release a certain amount of a quaternary ammonium compound with the solution as the solution is released, for example, when wrung, squeezed, or used to clean a surface. This amount of the quaternary ammonium compound can be termed quat depletion, and can be measured based on the weight percentage of the quaternary ammonium compound in the released solution. Quat depletion can depend on the original amount of the quaternary ammonium compound in the solution prior to treatment of the nonwoven material, and can be reduced by the amount of the quaternary ammonium compound absorbed into the nonwoven material. Quat depletion will thus be less than or equal to the weight percentage of the quaternary ammonium compound in the solution prior to treatment the nonwoven material. Quat depletion can be determined by titration of the solution released from the nonwoven material.

In certain embodiments, quat depletion can be at least about 20%, at least about 30%, at least about 40%, at least about 45%, at least about 50%, at least about 55%, or at least about 60% of the initial amount of the quaternary ammonium compound in the solution prior to treatment of the nonwoven material. Additionally or alternatively, the amount of sanitizing agent released from the nonwoven material can be greater than a certain threshold. For example, and not limitation, the amount of sanitizing agent released can be greater than about 800 ppm, greater than about 900 ppm, greater than about 1000 ppm, greater than about 1100 ppm, or greater than about 1200 ppm.

### Features of the Rough Outer Surface

In certain embodiments, the presently disclosed subject matter provides for improved nonwoven materials that can have at least one outer layer that forms a rough surface that is suited to cleaning applications. In such embodiments, the cleaning efficiency of the nonwoven materials can be analyzed by determining the percentage of a mess that is cleaned using the nonwoven materials. In certain embodiments, the nonwoven materials can have a cleaning efficiency that is greater than 15%, greater than 18%, greater than 20%, greater than 25%, greater than 30%, greater than 31%, or greater than 35%.

In certain embodiments, the nonwoven material can include a rough outer surface created by heating an outer layer of the nonwoven material. In certain embodiments, the basis weight of the outer layer is from about 5 gsm to about 50 gsm, or from about 10 gsm to about 40 gsm.

In certain embodiments, the outer layer comprises synthetic fibers. In certain embodiments, the synthetic fibers are bicomponent fibers. In particular embodiments, the bicomponent fibers are partially drawn with eccentric core sheath configuration. In certain other embodiments, bicomponent fibers may be combined with other synthetic fibers and/or cellulose fibers. A person having ordinary skill in the art will appreciate that choice of fiber for the outer layer can contribute to the roughness of the outer layer. For example, the type of fiber and its dtex value, thickness and stiffness can be selected to moderate the roughness of the outer layer. Additionally, blends of multiple different types of fibers can be used to moderate the roughness of the outer layer.

In particular embodiments, at least a portion of the outer layer is coated with a binder on its outer surface. The outer layer can be coated with a binder in amounts ranging from 1 to about 4 gsm, or from about 1 to about 2 gsm, or from about 2 to about 3 gsm. In certain embodiments, the binder can be with a carrier composition, as described above.

The outer surface is heated at a controlled temperature such that it crimps. In certain embodiments, the controlled temperature ranges from about 110° C. to about 200° C. In preferred embodiments, the controlled temperature ranges from about 135° C. to about 150° C.

After cooling, the outer surface feels rougher compared to materials heated to lower temperatures. For example, the crimping of the outer surface can create ridges on the outer surface to increase its roughness.

The roughness of the outer surface can be approximated by the static and kinetic coefficients of friction of the nonwoven material with the rough outer surface. In certain embodiments, the nonwoven material can have a static coefficient of friction ranging from about 0.01 to about 3, or from about 0.05 to about 2, or from about 0.08 to about 1.8, or from about 0.12 to about 1.5, or from about 0.13 to about 1, or from about 0.17 to about 0.8, or from about 0.20 to about 0.5, or from about 0.25 to about 0.4. In certain embodiments, the nonwoven material can have a kinetic coefficient of friction ranging from about 0.0001 to about 2.0, or from about 0.001 to about 1.5, or from about 0.01 to about 1.2, or from about 0.02 to about 1, or from about 0.05 to about 0.8, or from about 0.10 to about 0.50, or from about 0.15 to about 0.20. In certain embodiments, the static and kinetic coefficients of friction can be determined by measuring the amount of force necessary to rub the nonwoven material across a surface. A person having ordinary skill in the art will appreciate that the static and kinetic coefficients of friction can vary depending on the surface used to measure the coefficients of friction. For example, the methods described in Example 3 can be used to measure the coefficients of friction.

The surface opposite the rough outer surface may have diverse qualities. In certain embodiments, it may be rough to provide a second rough surface for scrubbing applications. For example, the opposite surface may also be heated at a controlled temperature such that it crimps. Where both outer surfaces are heated to create two rough surfaces, the heat can be controlled such that one surface crimps more than the other, to create a nonwoven material having two surfaces of different roughness. Additionally or alternatively, the two outer surfaces may be composed of the same or different fibers to further moderate their relative roughness. In other certain embodiments, the opposite surface may be softer and suitable for wiping surfaces or collecting and absorbing particles.

The rough outer surface is suitable for a broad range of cleaning applications where a rough nonwoven material is desirable to scrub or wipe a surface.

### Methods of Making the Materials

A variety of processes can be used to assemble the materials used in the practice of this disclosed subject matter to produce the materials, including but not limited to, traditional dry forming processes such as airlaying and carding or other forming technologies such as spunlace or airlace. Preferably, the materials can be prepared by airlaid processes. Airlaid processes include, but are not limited to, the use of one or more forming heads to deposit raw materials of differing compositions in selected order in the manufacturing process to produce a product with distinct strata. This allows great versatility in the variety of products which can be produced.

In one embodiment, the material is prepared as a continuous airlaid web. The airlaid web is typically prepared by disintegrating or defiberizing a cellulose pulp sheet or sheets, typically by hammermill, to provide individualized fibers. Rather than a pulp sheet of virgin fiber, the hammermills or other disintegrators can be fed with recycled airlaid edge trimmings and off-specification transitional material produced during grade changes and other airlaid production waste. Being able to thereby recycle production waste would contribute to improved economics for the overall process. The individualized fibers from whichever source, virgin or recycled, are then air conveyed to forming heads on the airlaid web-forming machine. A number of manufacturers make airlaid web forming machines suitable for use in the disclosed subject matter, including Dan-Web Forming of Aarhus, Denmark, M&J Fibretech A/S of Horsens, Denmark, Rando Machine Corporation, Macedon, N.Y. which is described in U.S. Pat. No. 3,972,092, which is incorporated herein in its entirety by reference thereto. Margasa Textile Machinery of Cerdanyola del Valles, Spain, and DOA International of Wels, Austria. While these many forming machines differ in how the fiber is opened and air-conveyed to the forming wire, they all are capable of producing the webs of the presently disclosed subject matter. The Dan-Web forming heads include rotating or agitated perforated drums, which serve to maintain fiber separation until the fibers are pulled by vacuum onto a foraminous forming conveyor or forming wire. In the M&J machine, the forming head is basically a rotary agitator above a screen. The rotary agitator may comprise a series or cluster of rotating propellers or fan blades. Other fibers, such as a synthetic thermoplastic fiber, are opened, weighed, and mixed in a fiber dosing system such as a textile feeder supplied by Laroche S. A. of Cours-La Ville, France. From the textile feeder, the fibers are air conveyed to the forming heads of the airlaid machine where they are further mixed with the comminuted cellulose pulp fibers from the hammer mills and deposited on the continuously moving forming wire. Where defined layers are desired, separate forming heads may be used for each type of fiber.

In certain embodiments, a binder can be sprayed, wiped, or otherwise applied to a portion of at least one outer surface of the nonwoven material. The binder can be directly applied to the nonwoven material. Alternatively, the binder can be combined with one or more other components, for example, one or more blocking agents, before being applied to the nonwoven material. For example, a carrier composition including a binder and one or more blocking agents can be mixed or agitated to form a homogenous mixture before being applied to the nonwoven material. In certain embodiments, the mixing of the carrier composition can be improved using a solvent, such as water.

The airlaid web is transferred from the forming wire to a calendar or other densification stage to densify the web, if necessary, to increase its strength and control web thickness. In one embodiment, the fibers of the web are then bonded by passage through an oven set to a temperature high enough to fuse the included thermoplastic or other binder materials. The temperature of the oven during this stabilization step may be controlled to produce the rough outer surface. In certain embodiments, the temperature of stabilization is from about 110° C. to about 200° C. In other certain embodiments, the roughness of the outer layer may be formed by reheating the nonwoven material after it has been formed and stabilized.

In a further embodiment, secondary binding from the drying or curing of a latex spray or foam application occurs in the same oven. The oven can be a conventional through-air oven, be operated as a convection oven, or may achieve the necessary heating by infrared or even microwave irradiation. In particular embodiments, the airlaid web can be treated with additional additives before or after heat curing.

In certain embodiments, after applying a binder (e.g., a binder that is part of a carrier composition), the nonwoven material is treated with a solution comprising a sanitizing agent. For example, the nonwoven material can be treated with the solution during or after conversion. In certain embodiments, the solution is applied by spraying the solution onto the nonwoven material. The spraying can be performed after converting the nonwoven material. However, a person of ordinary skill in the art will appreciate that the methods of applying the solution can vary depending on several factors, including the composition of the nonwoven material and the method of conversion.

### 6. EXAMPLES

The presently disclosed subject matter will be better understood by reference to the following Examples. The following examples are merely illustrative of the presently disclosed subject matter and they should not be considered as limiting the scope of the subject matter in any way.

### Example 1

### Two-Layer Nonwoven Material

The present Example provides a two-layer nonwoven material in accordance with the disclosed subject matter.

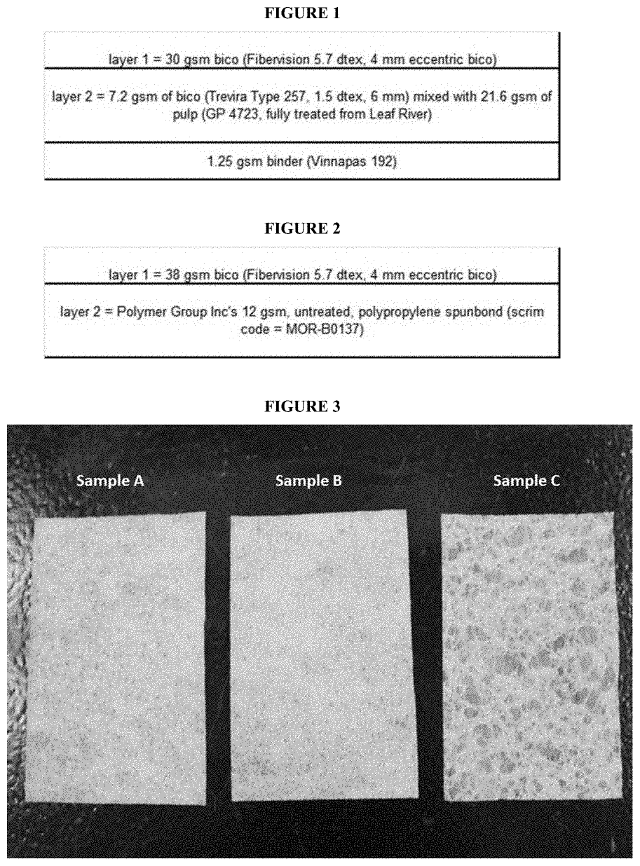

The material was formed using a pilot-scale drum-forming machine. The top layer of the two-layer nonwoven material was composed of 30 gsm of bicomponent fibers (5.7 dtex, 4 mm, from FiberVision). The bottom layer was composed of 7.2 gsm of regular bicomponent fibers (Trevira Type 257, 1.7 dtex, 6 mm) mixed with 21.6 gsm of cellulose (GP 4723, fully treated pulp from Georgia-Pacific Leaf River). This layer was bonded by spraying a polymeric binder in the form of emulsion (Vinnapas 192, from Wacker) in an amount of 1.25 gsm based on dry weight. FIG. 1 gives a pictorial description of the two-sided nonwoven material composition.

The surface topography and rigidity were controlled by the temperature at which the nonwoven material was stabilized. In general, at higher temperatures yielded products with harsher hand feel.

### Example 2

### Two-Layer Nonwoven Material

The present Example provides a two-layer nonwoven material in accordance with the disclosed subject matter.

The material was formed using a pilot-scale drum-forming machine. The top layer of the two-layer nonwoven material was composed of 38 gsm of bicomponent fibers (FiberVision, 5.7 dtex, 4 mm). The bottom layer was composed of a 12 gsm untreated, polypropylene spunbond nonwoven (code=MOR-B0137) supplied by Polymer Group Inc. FIG. 2 gives a pictorial description of the two-sided nonwoven material composition. Three samples of the same material were prepared: Sample A, Sample B, and Sample C.

The surface topography and rigidity were controlled by the temperature at which the nonwoven material was stabilized. Sample A was stabilized at 135° C. Sample B was stabilized at 138° C. Sample C was stabilized at 149° C.

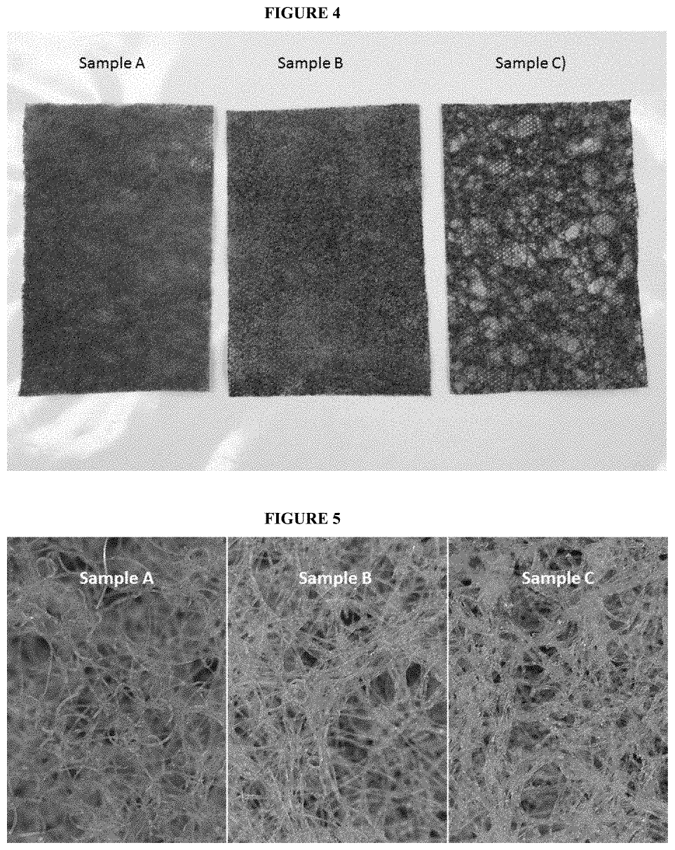

In general, higher temperatures yielded products with harsher hand feel. FIGS. 3 and 4 are photographs of the rough outer surfaces of Samples A, B and C. The photograph in FIG. 3 shows the samples without any additional treatment whereas the photograph in FIG. 4 shows the same samples after applying a dye.

FIG. 5 shows the microphotographs of the rough outer surfaces of Samples A, B and C. These microphotographs illustrate the various structures of fibrous networks in these samples created as a result of applying different temperatures at which these materials were stabilized.

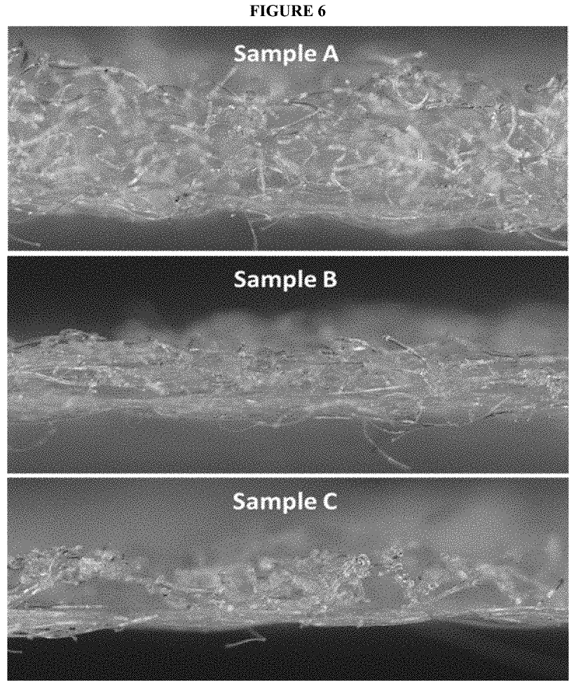

FIG. 6 shows the microphotographs of the cross-sections of Samples A, B and C. These microphotographs illustrate the various structures of fibrous networks in these samples created as a result of applying different temperatures at which these materials were stabilized.

### Example 3

### Coefficients of Friction of Rough Nonwoven Materials

The present Example provides the static and kinetic coefficients of friction of nonwoven materials whose surface topography and rigidity were stabilized at various processing temperatures. The static and kinetic coefficients of friction of a given material can correspond to the roughness of the material. Thus, the coefficients of friction can be used to approximate the roughness of a material.

The nonwoven materials of the present Example were airlaid nonwoven materials. Two types of airlaid nonwoven materials were prepared via the pilot airlaid machine. Each nonwoven material had two layers. The first layer was composed of 5.7 dtex, 4 mm eccentric bicomponent fibers from FiberVisions. The bottom layer was composed of cellulose fluff (GP 4725) mixed with Trevira Type 257 (1.5 dtex, 6 mm, PE/PP) bicomponent fibers. 1.25 gsm of Vinnapas 192 was sprayed on the bottom side to control dust. Products 101615-11, 101615-12, & 101615-13 were constructed, using Trevira Type 245 PET fibers (6.7 dtex, 3 mm) for the top layer. The topside was sprayed with 6 gsm of Vinnapas 192. The bottom layer was composed of cellulose fluff (GP 4725) & Trevira Type 257 (1.5 dtex, 6 mm, polyethylene (PE)/polypropylene (PP)) bicomponent fibers. 1.25 gsm of binder (Vinnapas 192) was sprayed on the outer surface of the bottom layer. Various samples had overall basis weights of 50 gsm, 60 gsm, 70 gsm and 80 gsm. Various samples were stabilized at target processing temperatures of 138° C., 143° C., and 147° C. to create a rough outer surface on the nonwoven materials.

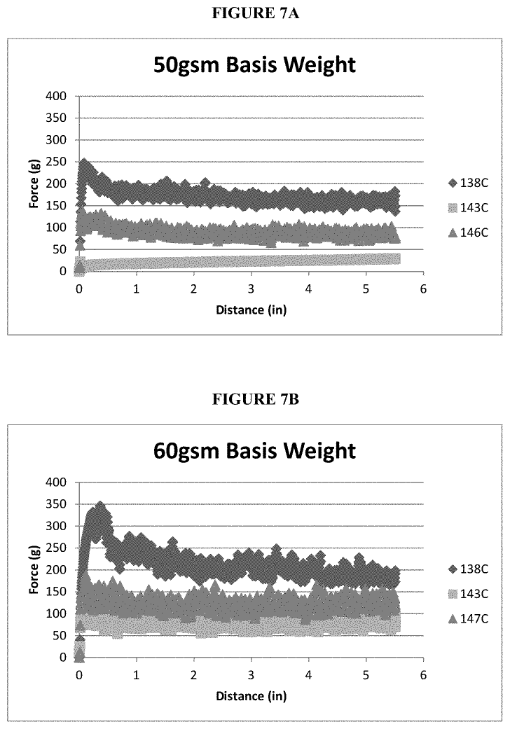

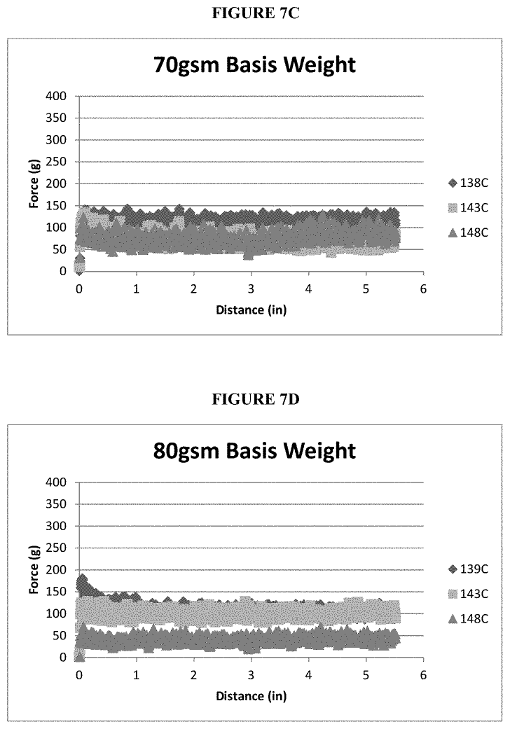

A Thwing-Albert FP-2260 Friction/Peel Tester was used to measure the static and kinetic coefficients of friction between the rough side of the nonwoven materials and a variety of surfaces. Samples of the nonwoven materials were cut and wrapped around a 200 g sled attached to a 2000 g load cell. The sled was pulled at a constant speed of 15 in/min and the force per distance values were recorded to create friction profiles for each nonwoven material. FIGS. 7A-7D provide the friction profiles of the various basis weight materials. FIG. 7A provides friction profiles for the 50 gsm materials, which were cured at processing temperatures of 138° C., 143° C., and 147° C. Similarly, FIGS. 7B, 7C, and 7D provide the friction profiles for the 60 gsm, 70 gsm, and 80 gsm materials, respectively. In lower basis weight nonwoven materials (e.g., 50 gsm and 60 gsm), the processing temperature during stabilization had a significant impact on the friction profile. These data suggest that controlling the processing temperature can impact the coefficients of friction and the roughness of nonwoven materials.

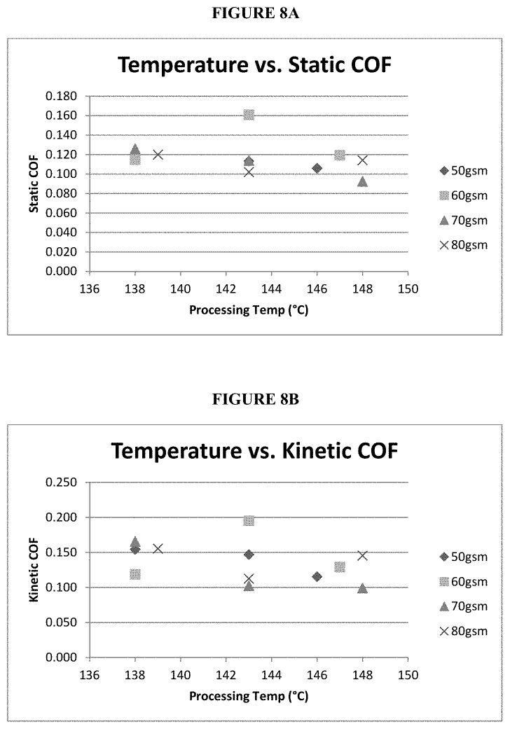

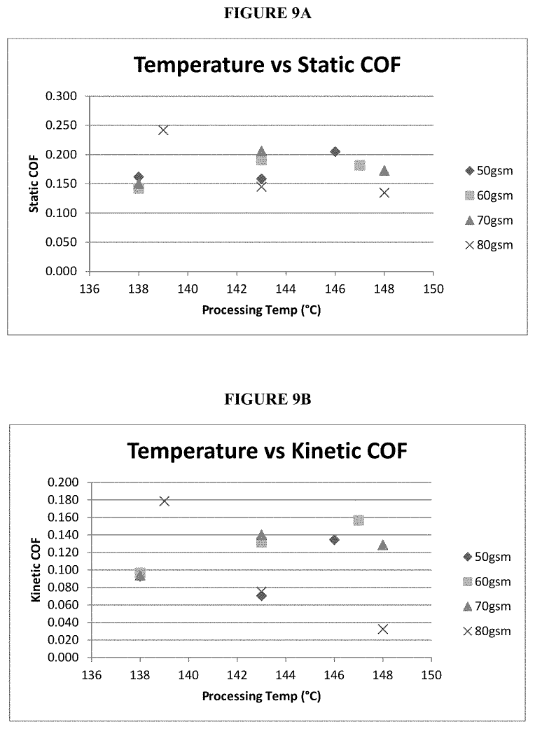

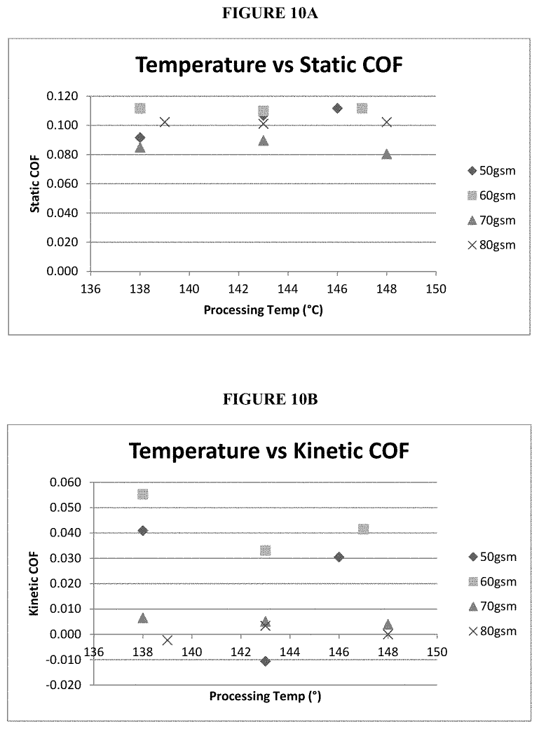

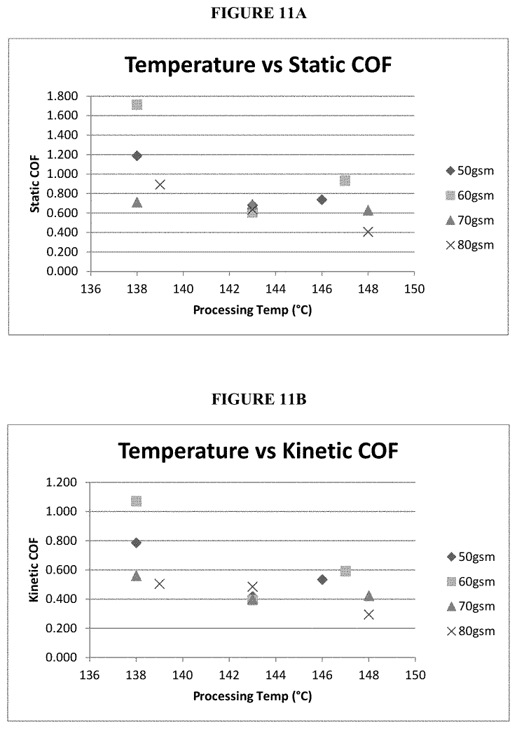

MAP-4 software was used to calculate static and kinetic coefficients of friction from the friction profiles. FIG. 8A provides the average static coefficient of friction and FIG. 8B provides the average kinetic coefficient of friction for the nonwoven materials across different processing temperatures when rubbed on a black glass surface. As shown in these Figures, the coefficients of friction were altered by varying the processing temperature. Similarly, FIGS. 9A and 9B provide the average static and kinetic coefficients of friction, respectively, for the nonwoven materials when rubbed on a ceramic surface. FIGS. 10A and 10B provide the average static and kinetic coefficients of friction, respectively, for the nonwoven materials when rubbed on a vinyl surface. FIGS. 11A and 11B provide the average static and kinetic coefficients of friction, respectively, for the nonwoven materials when rubbed against their own surfaces. These data suggest that the roughness of a nonwoven material can be altered by controlling the processing temperature during stabilization.

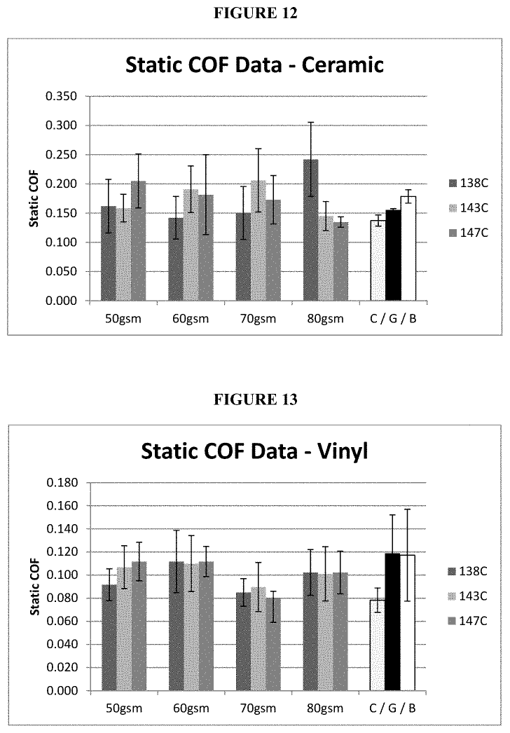

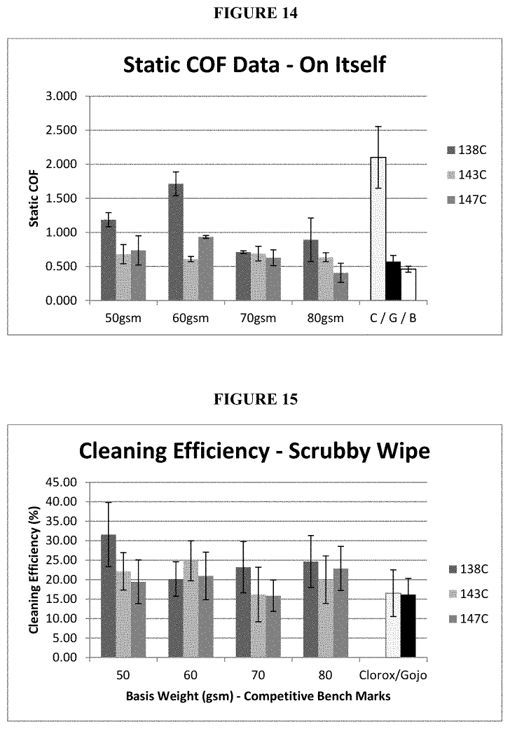

The same procedures were used to determine the static coefficient of friction for three commercially available materials. The commercially available materials were Clorox (“C”), Gojo (“G”), and Big Jobs (“B”). FIG. 12 provides the average static coefficients of friction for the nonwoven materials and the commercially available materials when rubbed on a ceramic surface, and FIG. 13 provides the same when rubbed on a vinyl surface. FIG. 14 provides the average static coefficients of friction of the nonwoven materials and the commercially available materials when rubbed against their own surfaces. As shown in these Figures, certain nonwoven materials having various processing temperatures can have increased coefficients of friction compared to commercially available materials. For example, in FIG. 12, and with respect to the 50 gsm nonwoven material, increasing the processing temperature of the nonwoven material can increase the static coefficient of friction to be greater than the static coefficient of friction of the commercially available materials.

### Example 4

### Cleaning Efficiency of Rough Nonwoven Materials

The present Example provides the cleaning efficiency of airlaid nonwoven materials whose surface topography and rigidity were stabilized at various processing temperatures.

The nonwoven materials were prepared via the pilot airlaid machine. Each nonwoven material had two layers. The top layer was composed of 5.7 dtex, 4 mm eccentric bicomponent fibers from FiberVisions. The bottom layer was composed of cellulose fluff (GP 4725) mixed with Trevira Type 257 (1.5 dtex, 6 mm, polyethylene (PE)/polypropylene (PP)) bicomponent fibers. 1.25 gsm of binder (Vinnapas 192) was sprayed on the outer surface of the bottom layer. Various samples had overall basis weights of 50 gsm, 60 gsm, 70 gsm and 80 gsm. Various samples were stabilized at processing temperatures ranging from 138° C. to 148° C.

To measure cleaning efficiency, standard procedure ASTM D4488-95 was performed. A BYK Gardner Spectrophotometer was used to record initial L values for clean 4 in.×4 in. flooring tiles. The flooring tiles were Armstrong 12 in.×12 in. chalk pattern Excelon Feature Tile, a commercially available vinyl tile. Each tile was dirtied with 0.05 g of urban soil, which was piled onto a portion of each tile. The tiles were further dirtied by adding an oil blend to the soil and swirling the soil into a circle having a diameter of about 2.5 in. The urban soil/oil blend was according to ASTM D4488 A5.4.2. Note that the soil was swirled using a paper towel and about 60-70% of the soil was removed by this process. The tiles were dried overnight. The spectrophotometer was used to record soiled L values for each tile, which correspond to the amount of soil on the dirtied tiles.

Using a Gardner Abrasion Tester, the dirtied tiles were wetted with 4:1 w/w standard water and cleaned using a sample of a nonwoven material for five cleaning cycles. The tiles were dried overnight. The spectrophotometer was used to record clean L values for each tile, which correspond to the amount of soil remaining.

Cleaning efficiency was quantified as the percentage of soil removed by the sample of nonwoven material. Particularly, cleaning efficiency was calculated by determining the amount of mess removed (i.e., the difference between the L values of the times after cleaning and the L values of the tiles before cleaning) as a percentage of the original amount of mess (i.e., the difference between the initial L values of the tiles and the L values of the tiles before cleaning). The formula of cleaning efficiency can be described as:

Cleaning Efficiency=[(L value of cleaned tile)−(L value of soiled tile)]/[(initial L value of tile)−(L value of soiled tile)]×100%

The test was repeated using two commercially available products (Clorox and Gojo) to provide a comparison. Table 1 provides the average cleaning efficiencies of samples having various basis weights and processing temperatures, as well as the average cleaning efficiencies of the commercially available products.

TABLE 1

| | | | % Cleaning | Standard |
|---|---|---|---|---|
| Sample | Basis Weight | Temp. | Efficiency | Deviation |
| 101615-1 | 50 | 138 | 31.56 | 8.25 |
| 101515-12 | 50 | 143 | 22.14 | 4.81 |
| 101515-11 | 50 | 146 | 19.45 | 5.63 |
| 101615-2 | 60 | 138 | 20.16 | 4.44 |
| 101615-3 | 60 | 143 | 24.82 | 5.12 |
| 101615-4 | 60 | 147 | 20.95 | 6.11 |
| 101615-8 | 70 | 138 | 23.19 | 6.57 |
| 101615-9 | 70 | 143 | 16.19 | 7.00 |
| 101615-10 | 70 | 148 | 15.86 | 4.01 |
| 101615-5 | 80 | 139 | 24.66 | 6.67 |
| 101615-6 | 80 | 143 | 19.98 | 6.10 |
| 101615-7 | 80 | 148 | 22.87 | 5.67 |
| Clorox | | | 16.51 | 5.99 |
| Gojo | | | 16.13 | 4.18 |

FIG. 15 provides a graphical representation of the data in Table 1. In FIG. 15, the shades of the bar correspond to the target processing temperature of the nonwoven material. Thus, for example, the 50 gsm nonwoven material that was stabilized at a target temperature of 147° C. was actually stabilized at a temperature of 146° C., as described in Table 1. These data show that in the lower basis weight materials, cleaning efficiency decreased as the processing temperature increased. This is perhaps due to the decrease in surface area caused by the increased crimping of the nonwoven materials at higher processing temperatures. Nonetheless, the nonwoven materials showed improved cleaning efficiency over commercially available products. Notably, the nonwoven materials having lower basis weights (e.g., 50 gsm and 60 gsm) showed significantly improved cleaning efficiency compared to commercially available products. These data suggest that the rough nonwoven materials of the presently disclosed subject matter have improved qualities compared to commercially available cleaning products.

### Example 5

### Cleaning Efficiency and Roughness of Nonwoven Materials

The present Example correlates the cleaning efficiency data provided in Example 4 with the roughness of the nonwoven materials.

The procedure described in Example 3 was used to generate a friction profile for each of the nonwoven materials of Example 4. The peak static force (i.e., the peak force on the friction profile) and the kinetic force (i.e., the average force applied to move the sled with the nonwoven material attached) were determined from the friction profiles.

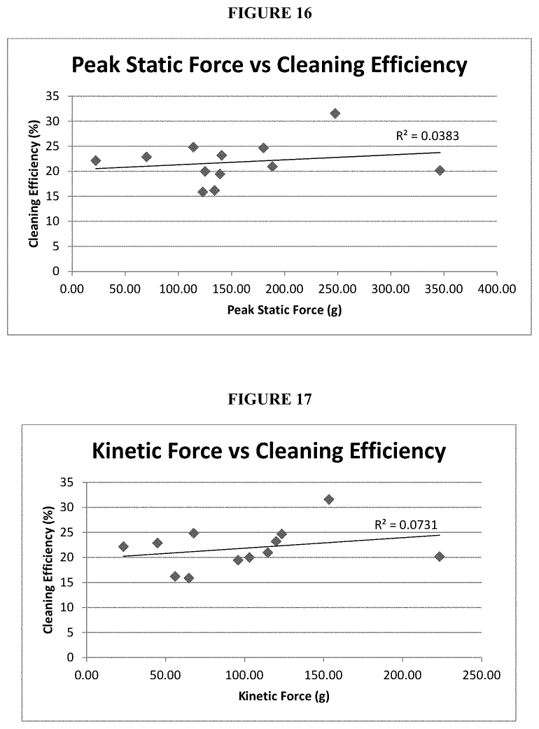

FIG. 16 provides a plot of the peak static force compared to the cleaning efficiency. FIG. 16 also includes a trend line, showing that cleaning efficiency increases as peak static force increases. Similarly, FIG. 17 provides a plot of the kinetic force compared to the cleaning efficiency, as well as a trend line. The trend line shows that cleaning efficiency increases as kinetic force increases.

Peak static force and kinetic force correspond to the static coefficient of friction and the kinetic coefficient of friction, respectively. As discussed above, the coefficients of friction can be used to approximate the roughness of a material. Thus, these data suggest that as the roughness of the nonwoven materials increases, so does the cleaning efficiency of those materials. Therefore, providing a rough outer surface to a nonwoven woven material can increase its utility for cleaning purposes.

### Example 6

### Nonwoven Materials for Sanitizing Wipes

This Example describes methods of preparing nonwoven materials that can be used as a support for a cationic compound, such as a quaternary ammonium salt. The nonwoven materials include cellulose fibers, and a carrier composition including a binder and a blocking agent.

In this Example, the raw materials included cellulose fibers (GI 4725, Georgia-Pacific Cellulose, fluff pulp), bicomponent fibers (Trevira Type 255, 2.2 dtex, 6 mm, polyethylene (PE)/polyethylene terephthalate (PET)), and a binder material (Dur-O-Set 25-010A, Celanese). The binder material was combined with one or more of potassium citrate monohydrate, Tergitol 15-S-12 (The DOW Chemical Company), and Polysorbate 20 (T-Maz 20, BASF) to form a carrier composition. Additionally, anionic pigments, including Solar P Blue 42L (BASF) and Solar P Black PR991L (BASF) were used.

Two airlaid nonwoven materials were prepared. The first material (Cell 1) was a multi-bonded airlaid (MBAL) material including both cellulose and bicomponent fibers, as well as a binder combined with potassium citrate monohydrate and T-Maz 20. The second material (Cell 2) was a latex bonded airlaid (LBAL) material including cellulose fibers and a binder combined with Tergitol 15-S-12. The compositions of Cell 1 and Cell 2 are shown in Tables 2 and 3, respectively. For both materials, the target basis weight was 100 gsm, and the target caliper was 0.95 mm.

TABLE 2
Overall Composition of Cell 1

| | % Solids in | Wt-% Solids in |
|---|---|---|
| Raw Material | Raw Material | Final Product |
| GI 4725 cellulose fibers | 100% | 74.083% |
| Trevira Type 255, 2.2 dtex, 6 mm | 100% | 18.800% |
| PE/PET bicomponent fibers | | |
| Dur-O-Set 25-010A binder | 52% | 5.100% |
| Potassium Citrate Monohydrate | 94% | 1.700% |
| T-Maz 20 (Polysorbate 20) | 100% | 0.300% |
| Solar P Blue 42L pigment | 100% | 0.014% |
| Solar P Black PR991L pigment | 100% | 0.003% |

TABLE 3
Overall Composition of Cell 2

| | % Solids in | Wt-% Solids in |
|---|---|---|
| Raw Material | Raw Material | Final Product |
| GI 4725 cellulose fibers | 100% | 83.983% |
| Dur-O-Set 25-010A binder | 52% | 14.000% |
| Tergitol 15-S-12 | 100% | 2.00% |
| Solar P Blue 42L pigment | 100% | 0.014% |
| Solar P Black PR991L pigment | 100% | 0.003% |

The carrier composition for each of Cell 1 and Cell 2 was prepared according to the following procedures. For Cell 1, the binder material, potassium citrate monohydrate, and T-Maz 20 were added in the amounts shown in Table 4, below. The potassium citrate monohydrate was added to 2800 L of warm water and agitated until the granules were completely dissolved. Then, the T-Maz 20 was added to this mixture and agitated. Finally, the binder material was added using a 2″ diaphragm pump and agitated. The binder solids was adjusted to 10% with water (resulting in the final volume of water added being 2900 L, as indicated in Table 4).

TABLE 4
Carrier Composition for Cell 1

| Raw Material | Quantity | Units |
|---|---|---|
| Dur-O-Set 25-010A binder | 486 | kg |
| Potassium Citrate Monohydrate | 90 | kg |
| T-Maz 20 (Polysorbate 20) | 15 | kg |
| Water | 2900 | L |

The procedure was similar for Cell 2. The binder material and Tergitol 15-S-12 were added in the amounts shown in Table 5, below. The Tergitol 15-S-12 was added to 2900 L of warm water and agitated until it completely dissolved. Then, the binder material was added using a 2″ diaphragm pump and agitated. The binder solids was adjusted to 18% with water (resulting in the final volume of water added being 2970 L, as indicated in Table 5).

TABLE 5
Carrier Composition for Cell 2

| Raw Material | Quantity | Units |
|---|---|---|
| Dur-O-Set 25-010A binder | 1333 | kg |
| Tergitol 15-S-12 | 99 | kg |
| Water | 2970 | L |

Additionally, for each of Cell 1 and Cell 2, the anionic pigments were combined prior to making the materials. Solar P Blue 42L pigment and Solar P Black PR991L pigment were combined with water in the amounts shown in Table 6, below. First, the Solar P Blue 42L pigment was added to 330 kg of warm water. The Solar P Black PR991L was then added, and the mixture was agitated. The target dye solids was 0.5%.

TABLE 6
Composition of Pigment Mixture

| Raw Material | Quantity | Units |
|---|---|---|
| Solar P Blue 42L pigment | 4.95 | kg |
| Solar P Black PR991L pigment | 1.06 | kg |
| Water | 330 | kg |

Both Cell 1 and Cell 2 were prepared on a full scale airlaid machine having two forming heads. Cell 1 was prepared as a two-layer material. The first layer contained 49.6 gsm of cellulose fibers and 11.3 gsm of bicomponent fibers. The second layer contained 24.4 gsm of cellulose fibers and 7.5 gsm of bicomponent fibers. The outer surfaces of each layer were each sprayed with 3.6 gsm of the carrier composition described above and 0.0085 gsm of the pigments. Cell 2 was likewise prepared as a two-layer material. The first layer contained 65.5 gsm of cellulose fibers and the second layer contained 18.5 gsm of cellulose fibers. The outer surfaces of each layer were each sprayed with 8.0 gsm of the carrier composition described above and 0.0085 gsm of the pigments.

Samples of Cell 1 and Cell 2 were embossed and tested for cross-direction wet tensile (CDW tensile) strength, machine-direction dry tensile (MDD tensile) strength, absorbency, and color. The materials were found to have good stability and low depletion of a cationic compound.

### Example 7

### Quat Depletion of Nonwoven Materials for Sanitizing Wipes

In this Example, nonwoven materials including multi-bonded airlaid (MBAL) materials or latex bonded airlaid (LBAL) materials, and including a carrier composition including a binder and a blocking agent were treated with a quaternary ammonium salt. Then, the materials were tested for release of the quaternary ammonium salt (i.e., “quat depletion”) to determine the amount of the quaternary ammonium compound released by the materials.

Each sample included either an LBAL or MBAL material that was treated with a mixture of a binder and one or more of potassium citrate monohydrate, Tergitol 15-S-12 (The DOW Chemical Company), and Polysorbate 20 (T-Maz 20, BASF). The materials were prepared on a pilot scale airlaid line. The binder used was either Dur-O-Set 10A (Celanese) or Vinnapas RB18 (Wacker). Table 7, below, indicates the material and binder type, as well as the blocking agent that was combined with the binder and its weight percent in the final product. Table 7 also provides the target basis weight of each sample, and weight percent of quaternary ammonium compound in a solution related from the samples for Samples 7A, 7B, 7E, 7H, 7L, and 7M. The method for determining the amount of quaternary ammonium compound in a solution related from the samples is described in greater detail in Example 8.

TABLE 7
Components of Samples 7A-7N

| | | | Binder | Target Basis | | Quat |
|---|---|---|---|---|---|---|
| # | Type | Additive (wt-%) | Type | Weight | | (wt-%) |
| 7A | LBAL | T-Maz 20 (2%) | Dur-O-Set 10A | 100 | gsm | 0.099% |
| 7B | LBAL | Tergitol 15-S-12(2%) | Dur-O-Set 10A | 100 | gsm | 0.135% |
| | | and T-Maz 20 (0.719%) | | | | |
| 7C | MBAL | Potassium Citrate | Dur-O-Set 10A | 80 | gsm | |
| | | Monohydrate (1%) | | | | |
| 7D | MBAL | Potassium Citrate | Dur-O-Set 10A | 80 | gsm | |
| | | Monohydrate (1%) | | | | |
| 7E | MBAL | Potassium Citrate | Dur-O-Set 10A | 90 | gsm | 0.139% |
| | | Monohydrate (1%) | | | | |
| 7F | MBAL | Potassium Citrate | Dur-O-Set 10A | 100 | gsm | |
| | | Monohydrate (1%) | | | | |
| 7G | MBAL | Potassium Citrate | Dur-O-Set 10A | 80 | gsm | |
| | | Monohydrate (1.7%) | | | | |
| 7H | MBAL | Potassium Citrate | Dur-O-Set 10A | 90 | gsm | 0.181% |
| | | Monohydrate (1.7%) | | | | |
| 7I | MBAL | Potassium Citrate | Dur-O-Set 10A | 100 | gsm | |
| | | Monohydrate (1.7%) | | | | |
| 7J | MBAL | Tergitol 15-S-12 (2%) | Dur-O-Set 10A | 80 | gsm | |
| 7K | MBAL | Tergitol 15-S-12 (2%) | Dur-O-Set 10A | 90 | gsm | |
| 7L | MBAL | Tergitol 15-S-12 (2%) | Dur-O-Set 10A | 100 | gsm | 0.158% |
| 7M | LBAL | Tergitol 15-S-12 (2%) | Dur-O-Set 10A | 100 | gsm | 0.152% |
| 7N | LBAL | Tergitol 15-S-12 (2%) | Vinnapas RB18 | 100 | gsm | |

As noted in Table 7, the lowest quat depletion was observed for the MBAL material with 1.7 wt-% potassium citrate monohydrate. The potassium citrate monohydrate was observed to have no detrimental affect binder performance. Both LBAL and MBAL materials with 2 wt-% Tergitol 15-S-12 were also found to have low quat depletion.

### Example 8

### Quat Depletion of Nonwoven Materials for Sanitizing Wipes

In this Example, nonwoven materials including multi-bonded airlaid (MBAL) materials or latex bonded airlaid (LBAL) materials were tested for quat depletion to determine the amount of the quaternary ammonium compound released. The materials included a carrier composition including a binder and a blocking agent and were treated with a quaternary ammonium compound.

Each sample included either an LBAL or MBAL material that was treated with a mixture of a binder and one or more of potassium citrate monohydrate, Tergitol 15-S-12 (The DOW Chemical Company), and Polysorbate 20 (T-Maz 20, BASF), with the exception of Samples 8K and 8L, which were controls that did not include a blocking agent. The binder used was one of Dur-O-Set 25-010A (Celanese), Dur-O-Set Elite Ultra 25-135A (Celanese), or Vinnapas RBG1 (Wacker).

Additionally, multiple control samples were used. Two controls (“Liquid Control 1” and “Liquid Control 2” in Table 8, below) were the solution containing a quaternary ammonium compound, which was not yet applied to a substrate, i.e., the “unapplied” solution. Additionally, a LBAL Control and a MBAL Control, each including a binder but no blocking agent were tested. Finally, a control corresponding to a finished product with a known 100 gsm LBAL product containing 11.4 wt-% of Dur-O-Set Elite Ultra 25-135A as the binder (“Product Control”) was also tested. Product Control and Sample 8K were prepared on a full scale airlaid line. LBAL Control, MBAL Control, Samples 8A-8J, and Samples 8L-8P were prepared on a pilot scale airlaid line.

Table 8, below, shows the material type, as well as the blocking agent that was combined with the binder and its weight percent in the final product. Unless otherwise indicated, the binder was Dur-O-Set 25-010A. The basis weight of Sample 8P was 70 gsm. The basis weights of Sample 8K, Sample 8N and Product Control were 100 gsm.

Quat depletion was tested according to two different methods, depending on the sample, as shown in Table 8. In a first method, labeled “titration,” the liquid solution was wrung from the material and manually titrated to determine the weight percent of the quat in the liquid. In a second method, labeled “surfactrode,” a surfactant electrode was used to perform the titration. Additionally, the MDD tensile strength of certain samples was tested according to WSP 110.4.R0, as shown in Table 8.

TABLE 8
Components of Samples 8A-8P and Controls

| | | | | MDD |
|---|---|---|---|---|
| | | Wt-% Quat | Wt-% Quat | Tensile |
| Sample | Description | (titration) | (surfactrode) | (gli) |
| Liquid | Unapplied solution | 0.27% | 0.292% | — |
| Control 1 | | | (assumed) | |
| Liquid | Unapplied solution | 0.26% | 0.292% | — |
| Control 2 | | | (assumed) | |
| LBAL | LBAL | 0.09% | — | 1437 |
| Control | | | | |
| 8A | LBAL with 0.41% | 0.09% | — | — |
| | T-Maz 20 | | | |
| 8B | LBAL with 0.62% | 0.09% | — | — |
| | T-Maz 20 | | | |
| 8C | LBAL with 2.5% | — | 0.191% | 249 |
| | Potassium Citrate | | | |
| | Monohydrate | | | |
| 8D | LBAL with 0.25% | — | 0.120% | 763 |
| | Potassium Citrate | | | |
| | Monohydrate | | | |
| 8E | LBAL with 0.83% | — | 0.169% | 322 |
| | Potassium Citrate | | | |
| | Monohydrate | | | |
| MBAL | MBAL | 0.10% | — | 963 |
| Control | | | | |
| 8F | MBAL with 0.22% | 0.105% | — | — |
| | T-Maz 20 | | | |
| 8G | MBAL with 0.44% | 0.12% | — | — |
| | T-Maz 20 | | | |
| 8H | MBAL with 1.76% | — | 0.197% | 776 |
| | Potassium Citrate | | | |
| | Monohydrate | | | |
| 8I | MBAL with 3.46% | — | 0.210% | 766 |
| | Potassium Citrate | | | |
| | Monohydrate | | | |
| 8J | LBAL with 2% | 0.14% | — | — |
| | Tergitol 15-S-12 | | | |
| 8K | LBAL Finished | 0.18% | — | — |
| | Product | | | |
| Product | Known LBAL | 0.10% | 0.115% | — |
| Control | Product with | | | |
| | Dur-O-Set Elite | | | |
| | Ultra 25-135A | | | |
| 8L | LBAL with | 0.10% | — | — |
| | Vinnapas RBG1 | | | |
| 8M | LBAL with | 0.18% | — | — |
| | Vinnapas RBG1 | | | |
| | and 2% Tergitol | | | |
| | 15-S-12 | | | |
| 8N | LBAL with 2% | 0.08% | — | — |
| | T-Maz 20 | | | |
| 8O | LBAL with 2% | 0.12% | — | — |
| | Tergitol 15-S-12 and | | | |
| | 0.76% T-Maz 20 | | | |
| 8P | MBAL with 1% | 0.15% | — | — |
| | Potassium Citrate | | | |
| | Monohydrate | | | |

As noted in Table 8, the liquid control had a quat wt-% of 0.27% or 0.292%, depending on the test method used. Accordingly, the maximum possible amount of quat remaining in solution is approximately in this range. Of the materials tested, those including potassium citrate monohydrate consistently had lower quat depletion as compared to the LBAL Control, MBAL Control, and Product Control 1. Additionally, these materials were generally improved as compared to those with T-Maz 20 and/or Tergitol 15-S-12. Moreover, the materials with T-Maz 20 and/or Tergitol 15-S-12 generally had lower quat depletion than the control materials. Thus, the presence of a carrier composition with a binder and a blocking agent can decrease quat depletion.

With respect to MDD tensile strength, the presence of a carrier composition tended to decrease strength as compared to the LBAL Control and MBAL Control.

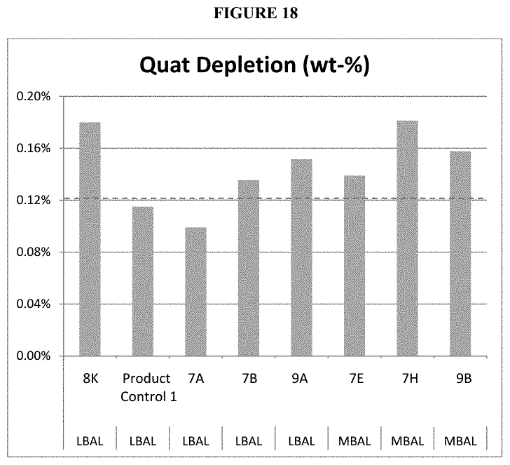

To better compare the quat depletion results, samples from Examples 2 and 3 are summarized in Table 9 below, along with additional Samples 9A and 9B. Sample 9A was a 90 gsm LBAL material prepared on a pilot scale airlaid line and Sample 9B was a 95 gsm MBAL material prepared on a pilot scale airlaid line. This data is also presented in FIG. 18. As indicated by the dashed line in FIG. 18, the minimum preferred amount of quat remaining in solution was about 0.12% for the cleaning solution used in these Examples (based on the initial amount of the quaternary ammonium compound used in the solution, i.e., about 0.292%).

TABLE 9
Summary of Results from Examples 7 and 8 and Samples 9A-9B

| | | | | Quat |
|---|---|---|---|---|
| Method | Structure | Sample | Description | (wt-%) |
| Production | LBAL | 8K | LBAL Finished Product | 0.180% |
| line | | | | |
| Production | LBAL | Product | Known LBAL Product | 0.115% |
| line | | Control 1 | | |
| Pilot line | LBAL | 7A | 2% T-Maz 20 (95 gsm) | 0.099% |
| Pilot line | LBAL | 7B | 2% Tergitol | 0.135% |
| | | | 15-S-12, 0.72% | |
| | | | T-Maz 20 (103 gsm) | |
| Pilot line | MBAL | 7E | 1% Potassium Citrate | 0.139% |
| | | | Monohydrate (91 gsm) | |
| Pilot line | MBAL | 7H | 1.7% Potassium Citrate | 0.181% |
| | | | Monohydrate (90 gsm) | |
| Pilot line | LBAL | 9A | 2% Tergitol 15-S-12 | 0.152% |
| | | | (90 gsm) | |
| Pilot line | MBAL | 9B | 2% Tergitol 15-S-12 | 0.158% |
| | | | (95 gsm) | |

Although the known LBAL Product was not able to achieve this amount of quat depletion, by comparison, materials with carrier composition had lower quat depletion. In particular, both LBAL and MBAL materials with Tergitol 15-S-12 (i.e., Samples 9A and 9B) achieved quat wt-% of greater than 0.15%. Moreover, an MBAL material with potassium citrate monohydrate (Sample 7H) achieved a quat wt-% of greater than 0.18%. Without being bound to a particular theory, it is believed that the blocking agents, i.e., potassium citrate monohydrate, Tergitol 15-S-12, and T-Maz 20, can effectively repel a cationic compound, such as a quaternary ammonium compound, from the surface of a nonwoven material, thereby allowing its later release within a cleaning solution. As such, the use of a carrier composition including both a binder and a blocking agent can improve quat depletion.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

Various patents and patent applications are cited herein, the contents of which are hereby incorporated by reference herein in their entireties.

1. A nonwoven material, comprising:
a first outer layer comprising synthetic fibers;
a second outer layer comprising cellulose fibers and/or synthetic fibers; and a carrier composition comprising a binder and a blocking agent, wherein the binder is present in the nonwoven material in an amount of from about 2 wt-% to about 30 wt-% and the blocking agent is present in the nonwoven material in an amount of from about 0.1 wt-% to about 10 wt-%,
wherein the first outer layer has a static coefficient of friction ranging from about 0.01 to about 3.0 and a kinetic coefficient of friction ranging from about 0.0001 to about 2.0.

2. The multi-layer nonwoven material of claim 1, wherein the nonwoven material comprises:
from about 10 wt-% to about 90 wt-% of cellulose fibers; and
from about 10 wt-% to about 90 wt-% of synthetic fibers.

3. The multi-layer nonwoven material of claim 1, wherein the synthetic fibers are bicomponent fibers.

4. The multi-layer nonwoven material of claim 1, wherein the first layer further comprises cellulose fibers and the second layer comprises both cellulose fibers and synthetic fibers.

5. The multi-layer nonwoven material of claim 1, wherein the blocking agent is an alkali metal salt.

6. (canceled)

7. (canceled)

8. The multi-layer nonwoven material of claim 1, wherein the blocking agent is a non-ionic surfactant.

9. The multi-layer nonwoven material of claim 8, wherein the nonionic surfactant is an alcohol ethoxylate compound or a polysorbate compound.

10. (canceled)

11. (canceled)

12. The multi-layer nonwoven material of claim 1, wherein the binder is a cationic binder.

13. The multi-layer nonwoven material of claim 1, wherein the nonwoven material has a basis weight of from about 30 gsm to about 200 gsm.

14. The multi-layer nonwoven material of claim 1, wherein the nonwoven material has a caliper of from about 0.3 mm to about 2.0 mm.

15. The multi-layer nonwoven material of claim 1, wherein the nonwoven material has a CDW tensile strength of greater than about 200 g/inch.

16. (canceled)

17. The multi-layer nonwoven material of claim 1, wherein the nonwoven material has a MDD tensile strength of greater than about 300 g/inch

18. (canceled)

19. The multi-layer nonwoven material of claim 1, further comprising a solution comprising a sanitizing agent.

20. (canceled)

21. The multi-layer nonwoven material of claim 19, wherein the sanitizing agent is a quaternary ammonium compound.

22. (canceled)

23. The multi-layer nonwoven material of claim 19, wherein the nonwoven material has a quat depletion of at least about 40% as compared to an initial amount of the quaternary ammonium compound in the solution before the solution is applied to the nonwoven material.

24. The multi-layer nonwoven material of claim 1, further comprising an antimicrobial agent.

25. The multi-layer nonwoven material of claim 1, further comprising an intermediate layer.

26. The multi-layer nonwoven material of claim 25, wherein the intermediate layer comprises cellulose fibers.

27. The multi-layer nonwoven material of claim 25, wherein the intermediate layer comprises bicomponent fibers.

28. The multi-layer nonwoven material of claim 1, wherein the first outer layer comprises bicomponent fibers having a first dtex value and the second outer layer comprises bicomponent fibers having a second dtex value, and wherein the first dtex value is greater than the second dtex value.

29. (canceled)

30. (canceled)

31. (canceled)
